(19) United States
(12) Patent Application Publication
(10) Pub. No.: US 2026/0176291 A1
(43) Pub. Date: Jun. 25, 2026

(54) HARNESSING MECHANOCHEMISTRY FOR DIRECT SYNTHESIS OF IMINE-BASED METAL-ORGANIC FRAMEWORKS

(71) Applicant: Ohio University, Athens, OH (US)

(72) Inventors: Wenyang Gao, Lutherville Timonium, MD (US); Zhuorigebatu Tegudeer, Athens, OH (US)

(21) Appl. No.: 19/425,255

(22) Filed: Dec. 18, 2025

Related U.S. Application Data
(60) Provisional application No. 63/736,762, filed on Dec. 20, 2024.
(60) Provisional application No. 63/942,120, filed on Dec. 16, 2025.

(51) Int. Cl. C07F 7/00; C07F 1/08

(52) U.S. Cl. CPC C07F 7/003; C07F 1/08

(57) ABSTRACT

The growth of metal-organic frameworks (MOFs) is most frequently accessed by direct assembly of metal cations and multitopic ready-to-connect ligands under solvothermal conditions. However, such nonambient conditions are expected to impose a synthetic challenge to incorporate degradable ligands into MOFs. This explains why imine-based MOFs are scarce, as the imine motif is usually prone to decompose through hydrolysis. This work not only showcases mechanochemistry as an ambient, sustainable, and high-yield strategy for synthesizing a variety of imine-based MOFs, but also achieves the integration of ligand synthesis and MOF growth into a single tandem step. Thus, this work provides straightforward access to imine-based MOFs, a subfamily of historically challenging MOF materials.

### CROSS-REFERENCE TO RELATED APPLICATIONS

This application claims the benefit of U.S. Provisional Application No. 63/736,762 filed Dec. 20, 2024, and U.S. Provisional Application No. 63/942,120 filed Dec. 16, 2025, each of which is hereby incorporated by reference herein in their entireties for all purposes.

### STATEMENT OF FEDERAL FUNDING

This invention was made with government support under Grant Number 2345469 awarded by the National Science Foundation. The government has certain rights in the invention.

### FIELD OF INVENTION

The field of the invention pertains to metal-organic frameworks (MOFs) and methods for their production, more specifically to methods of synthesis of MOFs including an imine group.

### BACKGROUND OF INVENTION

This section is intended to introduce the reader to various aspects of art that may be related to various aspects of the present invention, which are described and/or claimed below. This discussion is believed to be helpful in providing the reader with background information to facilitate a better understanding of various aspects of the present invention. Accordingly, it should be understood that these statements are to be read in this light, and not as admissions of prior art.

Mechanochemistry, driving the occurrence of chemical reactions using mechanical forces, instead of well-accepted heat, electricity, or light, is resurging into a sustainable synthetic strategy to access functional porous materials, including metal-organic frameworks (MOFs), covalent organic frameworks (COFs), and discrete cage compounds. Notable advantages of mechanochemical synthesis lie in solvent volume reduction, short reaction time, high reaction yield, and easiness to scale-up, associated with less energy input. Thus, mechanochemistry has been developed into a viable and sustainable means to access several classic MOFs, such as HKUST-1, ZIF-8, MOF-5, MOF-74, Ui0s, MIL-53, pillar-layered structures, and others.

Conventional methods for the synthesis of MOFs typically depend on solvothermal reactions, which combine organic ligands and metal salts in the presence of an excessive amount of organic solvent(s) (e.g., N,N-dimethylformamide (DMF)), sometimes with the addition of modulating reagents, in autoclaves or other sealed containers under autogenic pressure at elevated temperature. It is envisioned that such relatively harsh reactions may impose a fundamental challenge to introduce ligands that are degradable under those nonambient conditions. Given the experimental milling set-up to accomplish mechanochemistry, the solid phase reaction with no or a minimum amount of solvent at ambient temperature presents an exceptional opportunity to eliminate potential decomposition pathways for sensitive ligands and/or metal nodes, which are not compatible with solvothermal conditions. For example, imine-based ligands represent one type of these degradable ligands due to facile hydrolysis into its precursors—aldehyde and primary amine. This explains why the utilization of the imine moiety as the foundational strut of organic linkers in constructing MOFs remains rare, especially when contrasted with the extensive repertoire of multidentate ligands featuring diverse functional groups and connectivities frequently employed in MOF synthesis.

Various attempts have been made to transfer the imine moiety to MOFs in the past. These include (1) linker exchange, and (2) in situ imine formation. In linker exchange, the direct employment of an imine-based ligand to yield PCN-161 under solvothermal conditions has not been successful (FIG. 1A), as the imine moiety undergoes decomposition. Thus, a stable azobenzene-based ditopic ligand was pre-installed into the MOF lattice, which allows postsynthetic linker metathesis using the imine ligand to afford PCN-161 (FIG. 1A)][S. Yuan, L. Zou, J.-S. Qin, J. Li, L. Huang, L. Feng, X. Wang, M. Bosch, A. Alsalme, T. Cagin, H.-C. Zhou, Nat. Commun. 2017, 8, 15356]. The linker exchange was achieved without acid modulator at a temperature lower than the typical solvothermal temperature. Furthermore, the imine-based MOFs proved to be a useful tool to control the pore size of MOFs [S. Yuan, L. Zou, J.-S. Qin, J. Li, L. Huang, L. Feng, X. Wang, M. Bosch, A. Alsalme, T Cagin, H.-C. Zhou, Nat. Commun. 2017, 8, 15356.][L. Feng, S. Yuan, J.-S. Qin, Y Wang, A. Kirchon, D. Qiu, L. Cheng, S. T. Madrahimov, H.-C. Zhou, Matter 2019, 1, 156-167]. However, while linker exchange was known to introduce the imine-based ligand to the pre-formed MOF at relatively ambient temperature without the acid modulator, the direct solvothermal reaction involved with the imine linker could not deliver the desired structure, due to the decomposition of the imine linker. In in situ imine formation, solvothermal reactions, which allow the imine condensation and MOF growth in one pot (FIG. 1B), were reported later with quite low reaction yield (≤27%) [U. S. F. Arrozi, V Bon, S. Krause, T. Lubken, M. S. Weiss, I. Senkovska, S. Kaskel, Inorg. Chem. 2020, 59, 350-359]. In particular, the in-situ imine formation was developed via solvothermal reactions with rather limited reaction yield (≤27%) for 48 h. Their extensive attempts to obtain the reported synthetic condition further highlight the sensitivity of imine-based linkers toward the solvothermal condition as well as the modulating reagents.

Therefore, a straightforward direct synthetic approach to effectively and efficiently incorporating the degradable organic motifs (e.g., imines) into MOF lattices remains unique and is highly desirable.

### SUMMARY OF THE INVENTION

Certain exemplary aspects of the invention are set forth below. It should be understood that these aspects are presented merely to provide the reader with a brief summary of certain forms the invention might take and that these aspects are not intended to limit the scope of the invention. Indeed, the invention may encompass a variety of aspects that may not be explicitly set forth below.

As noted, the growth of metal-organic frameworks (MOFs) is most frequently accessed by direct assembly of metal cations and multitopic ready-to-connect ligands under solvothermal conditions. However, such nonambient conditions are expected to impose a synthetic challenge to incorporate degradable ligands into MOFs. This explains why imine-based MOFs are scarce, as the imine motif is usually prone to decompose through hydrolysis. The work of the present inventors, described herein, not only showcases mechanochemistry as an ambient, sustainable, and high-yield strategy for synthesizing a variety of imine-based MOFs, but also achieves the integration of ligand synthesis and MOF growth into a single tandem step. Thus, this work provides straightforward access to imine-based MOFs, a subfamily of historically challenging MOF materials.

And so, one aspect of the present invention is directed to a MOF, where the MOF is comprised of a linker molecule and a metal cluster. In this aspect, the linker molecule comprises an imine group and a linking moiety and the metal cluster comprises a plurality of metal atoms bound to oxygen atoms. The metal cluster is configured to coordinate with the linking moiety of the MOF.

Another aspect of the present invention is directed to a mechanochemical method of synthesizing an MOF. The mechanochemical method comprises linking at least two metal clusters using at least one linking molecule by applying mechanochemical force. The linking molecule comprises a first aromatic ring and a second aromatic ring, and each aromatic ring contains at least one linking moiety as a function group attached thereto. Each linking moiety is configured to coordinate with at least two metal clusters and an amine group. Each metal cluster comprises a plurality of metal atoms bound to oxygen atoms, and each metal cluster is configured to coordinate with the linking moiety.

### BRIEF DESCRIPTION OF THE DRAWINGS

The accompanying drawings, which are incorporated herein and constitute a part of this specification, illustrate embodiments of the invention and, together with the general description of the invention given above and the detailed description of the embodiments given below, serve to explain the principles of the present invention.

FIG. 1A shows a prior art process for linker exchange.

FIG. 1B shows a prior art process for in situ imine formation.

FIG. 1C shows a mechanochemical synthesis method according to an aspect of the present invention.

FIG. 2A shows representations for mechanochemical synthesis of H₂L¹, stepwise mechanochemical synthesis of [Zr₆O₄(OH)₄(L¹)₆], and one-pot mechanochemical synthesis of [Zr₆O₄(OH)₄(L¹)₆].

FIG. 2B shows PXRD patterns were collected from the one-pot prepared [Zr₆O₄(OH)₄(L¹)₆](bottom line) and the stepwise obtained [Zr₆O₄(OH)₄(L¹)₆](middle line), which are consistent with the calculated patterns of [Zr₆O₄(OH)₄(L¹)₆](top line), also known as PCN-161.

FIG. 2C shows N₂ adsorption isotherms at 77 K were collected from the stepwise mechanochemically obtained [Zr₆O₄(OH)₄(L¹)₆](adsorption (●), desorption (◯), darker circles) and the one-pot mechanochemically obtained [Zr₆O₄(OH)₄(L¹)₆](adsorption (●), desorption (◯), lighter circles).

FIG. 3A shows schematic representations for mechanochemical synthesis of H₂L¹, stepwise mechanochemical synthesis [Hf₆O₄(OH)₄(L¹)₆], and one-pot mechanochemical synthesis of [Hf₆O₄(OH)₄(L¹)₆].

FIG. 3B shows schematic representations for mechanochemical synthesis of H₂L², stepwise mechanochemical synthesis of [Zr₆O₄(OH)₄(L²)₆], and one-pot mechanochemical synthesis of [Zr₆O₄(OH)₄(L²)₆].

FIG. 3C shows PXRD patterns were collected from the one-pot prepared [Zr₆O₄(OH)₄(L²)₆](bottom line), the stepwise obtained [Zr₆O₄(OH)₄(L²)₆](middle-bottom line), the one-pot prepared [Hf₆O₄(OH)₄(L¹)₆](middle-top line), and the stepwise obtained [Hf₆O₄(OH)₄(L¹)₆](top line), which are consistent with the calculated patterns of [Zr₆O₄(OH)₄(L²)₆](middle line), also known as DUT-133.

FIG. 4A shows schematic representations for mechanochemical synthesis of H₂L³, stepwise [Zr₆O₄(OH)₄(L³)₆] and one-pot [Zr₆O₄(OH)₄(L³)₆].

FIG. 4B shows schematic representations for mechanochemical synthesis of H₂L⁴, stepwise [Zr₆O₄(OH)₄(L⁴)₆] and one-pot [Zr₆O₄(OH)₄(L⁴)₆].

FIG. 4C shows PXRD patterns were collected from the one-pot prepared [Zr₆O₄(OH)₄(L³)₆](bottom line), the stepwise obtained [Zr₆O₄(OH)₄(L³)₆](bottom-middle line), the one-pot prepared [Zr₆O₄(OH)₄(L⁴)₆](middle line), and the stepwise obtained [Zr₆O₄(OH)₄(L⁴)₆](middle-top line), which are consistent with the calculated patterns of [Zr₆O₄(OH)₄(L⁴)₆](top line), also known as PCN-164.

FIG. 5A shows schematic representations for mechanochemical synthesis of [Zr₆O₄(OH)₄(L⁵)₆]. This MOF featuring intramolecular hydrogen bonding cannot be directly accessed by the developed stepwise or one-pot mechanochemical synthesis using the corresponding precursors. However, the dynamic imine bonds enable ligand exchange of [Zr₆O₄(OH)₄(L³)₆] with 2,5-dihydroxyterephthalaldehyde to deliver [Zr₆O₄(OH)₄(L⁵)₆].

FIG. 5B shows PXRD patterns were collected from the obtained [Zr₆O₄(OH)₄(L⁵)₆](top line) and [Zr₆O₄(OH)₄(L³)₆](middle line), which are consistent with the calculated patterns of PCN-164 (bottom line).

FIG. 6A shows schematic representations for mechanochemical synthesis of H₄L⁶, stepwise [Cu₂(L⁶)] and one-pot [Cu₂(L⁶)].

FIG. 6B shows PXRD patterns were collected from the stepwise obtained [Cu₂(L⁶)](middle line) and the one-pot prepared [Cu₂(L⁶)](bottom line), which are comparable to the calculated patterns of [Cu₂(PDEB)](top line). The slightly shorter linker length of H₄L⁶ than that of H₄PDEB leads to PXRD peaks of [Cu₂(L⁶)] shifting toward the higher angle direction.

FIG. 6C shows N₂ adsorption isotherms at 77 K were collected from the stepwise obtained [Cu₂(L⁶)](adsorption (●), desorption (◯), darker circles) and the one-pot prepared [Cu₂(L⁶)](adsorption (●), desorption (◯), lighter circles).

FIG. 7 shows the ¹H NMR spectrum of the reaction mixture was acquired in d₆-DMSO at 23° C. directly after milling (without any further purifications) to obtain H₂L¹. The integrated peaks are assigned to the desired protons of H₂L¹.

FIG. 8 shows IR spectra (3600-400 cm⁻¹) were collected from 4-formylbenzoic acid (bottom), 4-aminobenzoic acid (middle), and the mechanochemically obtained ligand H₂L¹ (top). The disappearance of N—H stretches between 3480 cm⁻¹ and 3360 cm⁻¹ from the amine group highlights the formation of imine bond.

FIG. 9 shows PXRD patterns were collected from a series of experiments that examine the amount of the DMF additive to the stepwise mechanochemical synthesis of [Zr₆O₄(OH)₄(L¹)₆]: Line 1, η=0 μL/mg; Line 2, η=0.30 μL/mg; Line 3, η=0.60 μL/mg; Line 4, η=0.90 μL/mg; Line 5, η=1.05 μL/mg; Line 6, η=1.20 μL/mg; Line 7, η=1.35 μL/mg; Line 8, η=1.50 μL/mg. The amount of DMF between η=0.60 μL/mg and η=1.05 μL/mg is recognized to be the optimal condition. Lines are numbered with Line 1 being the bottom most line.

FIG. 10 shows IR spectra (3800-400 cm⁻¹) were collected from the mechanochemically obtained ligand H₂L¹ (Bottom Line), the stepwise mechanochemically obtained [Zr₆O₄(OH)₄(L¹)₆](Middle Line), and the one-pot mechanochemically synthesized [Zr₆O₄(OH)₄(L¹)₆](Top Line).

FIG. 11 shows PXRD patterns were collected from a series of experiments that examine the amount of the DMF additive to the one-pot mechanochemical synthesis of [Zr₆O₄(OH)₄(L¹)₆]: Bottom Line, η=0.60 μL/mg; Middle-Bottom Line, η=0.90 μL/mg; Middle-Top Line, η=1.20 μL/mg; Top Line, η=1.50 μL/mg. The amount of DMF between η=0.90 μL/mg and η=1.50 μL/mg provides comparable PXRD patterns.

FIG. 12 shows plots of weight % vs. temperature were recorded by thermogravimetric analysis of the one-pot mechanochemically obtained [Zr₆O₄(OH)₄(L¹)₆](Darker Line) and the stepwise mechanochemically obtained [Zr₆O₄(OH)₄(L¹)₆](Lighter Line).

FIG. 13 shows surface area values of the stepwise mechanochemically obtained [Zr₆O₄(OH)₄(L¹)₆] and the one-pot mechanochemically obtained one derived from N₂ adsorption isotherms at 77 K (FIG. 2C).

FIG. 14 shows IR spectra (4000-400 cm⁻¹) was collected from the mechanochemically obtained linker (Bottom Line), the stepwise mechanochemically obtained [Hf₆O₄(OH)₄(L¹)₆](Middle Line), and the one-pot mechanochemically [Hf₆O₄(OH)₄(L¹)₆](Top Line).

FIG. 15 shows plots of weight % vs. temperature were recorded by thermogravimetric analysis of the one-pot mechanochemically obtained [Hf₆O₄(OH)₄(L¹)₆](Darker Line) and the stepwise mechanochemically obtained [Hf₆O₄(OH)₄(L¹)₆](Lighter Line).

FIG. 16 shows N₂ adsorption isotherms at 77 K were collected from the stepwise mechanochemically obtained [Hf₆O₄(OH)₄(L¹)₆](adsorption (●), desorption (◯), darker circles) and the one-pot mechanochemically obtained [Hf₆O₄(OH)₄(L¹)₆](adsorption (●), desorption (◯), lighter circles).

FIG. 17 shows surface area values of the stepwise mechanochemically obtained [Hf₆O₄(OH)₄(L¹)₆] and the one-pot mechanochemically obtained one derived from N₂ adsorption isotherms at 77 K.

FIG. 18 shows the ¹H NMR spectrum of the reaction mixture was acquired in d₆-DMSO at 23° C. directly after milling (without any further purifications) to obtain H₂L². The integrated peaks are assigned to the desired protons of H₂L².

FIG. 19 shows IR spectra (3600-400 cm⁻¹) was collected from 4-formyl-3-hydoxylbenzoic acid (Top Line), 4-aminobenzoic acid (Middle Line), the mechanochemically obtained H₂L² (Bottom Line).

FIG. 20 shows PXRD patterns were collected from a series of experiments that examine the amount of the DMF additive to the one-pot mechanochemical synthesis of [Zr₆O₄(OH)₄(L²)₆]: Bottom Line, η=0.60 μL/mg; Middle-Bottom Line, η=0.90 μL/mg; Middle-Top Line, η=1.35 μL/mg; Top Line, η=1.50 μL/mg. The amount of DMF between η=1.35 μL/mg and η=1.50 μL/mg provides comparable defined PXRD patterns.

FIG. 21 shows IR spectra (3600-400 cm⁻¹) was collected from H₂L² (Bottom Line), the stepwise mechanochemically obtained [Zr₆O₄(OH)₄(L²)₆](Middle Line), and the one-pot mechanochemically prepared [Zr₆O₄(OH)₄(L²)₆](Top Line).

FIG. 22 shows plots of weight % vs. temperature were recorded by thermogravimetric analysis of the stepwise mechanochemically obtained [Zr₆O₄(OH)₄(L²)₆](Darker Line) and the one-pot mechanochemically obtained [Zr₆O₄(OH)₄(L²)₆](Lighter Line).

FIG. 23 shows N₂ adsorption isotherms at 77 K were collected from the stepwise mechanochemically obtained [Zr₆O₄(OH)₄(L²)₆](adsorption (●), desorption (◯), Darker Circles) and the one-pot mechanochemically obtained [Zr₆O₄(OH)₄(L²)₆](adsorption (●), desorption (◯), Lighter Circles).

FIG. 24 shows surface area values of the stepwise mechanochemically obtained [Zr₆O₄(OH)₄(L²)₆] and the one-pot mechanochemically obtained one derived from N₂ adsorption isotherms at 77 K.

FIG. 25A shows PXRD patterns were collected from a series of experiments that examine the moisture stability (at a humidity level of ˜55%) of imine-based MOF [Zr₆O₄(OH)₄(L¹)₆](t=0 h, bottom line; t=1 h, middle-bottom line; t=3 h, middle line; t=8 h, middle-top line; t=24 h, top line).

FIG. 25B shows PXRD patterns were collected from a series of experiments that examine the moisture stability (at a humidity level of ˜55%) of imine-based MOF [Zr₆O₄(OH)₄(L²)₆](t=0 h, bottom line; t=1 h, middle-bottom line; t=3 h, middle line; t=8 h, middle-top line; t=24 h, top line).

FIG. 26 shows the ¹H NMR spectrum of the reaction mixture was acquired in d₆-DMSO at 23° C. directly after milling (without any further purifications) to obtain H₂L³. The integrated peaks are assigned to the desired protons of H₂L³.

FIG. 27 shows the ¹H NMR spectrum of the reaction mixture was acquired in d₆-DMSO at 23° C. directly after milling (without any further purifications) to obtain H₂L⁴. The integrated peaks are assigned to the desired protons of H₂L⁴.

FIG. 28 shows IR spectra (3600-400 cm⁻¹) were collected from terephthalaldehyde (bottom line), 4-aminobenzoic acid (middle line), and the mechanochemically obtained ligand H₂L³ (top line).

FIG. 29 shows IR spectra (3600-400 cm⁻¹) were collected from 4-formylbenzoic acid (bottom line), 1,4-phenylenediamine (middle line), and the mechanochemically obtained ligand H₂L⁴ (top line).

FIG. 30 shows IR spectra (3800-400 cm⁻¹) was collected from H₂L³ (bottom line), the stepwise mechanochemically obtained [Zr₆O₄(OH)₄(L³)₆](middle line), and the one-pot mechanochemically prepared [Zr₆O₄(OH)₄(L³)₆](top line).

FIG. 31 shows IR spectra (3800-400 cm⁻¹) was collected from H₂L⁴ (bottom line), the stepwise mechanochemically obtained [Zr₆O₄(OH)₄(L⁴)₆](middle line), and the one-pot mechanochemically prepared [Zr₆O₄(OH)₄(L⁴)₆](top line).

FIG. 32 shows plots of weight % vs. temperature were recorded by thermogravimetric analysis of the stepwise mechanochemically obtained [Zr₆O₄(OH)₄(L³)₆](darker line) and the one-pot mechanochemically obtained [Zr₆O₄(OH)₄(L³)₆](lighter line).

FIG. 33 shows plots of weight % vs. temperature were recorded by thermogravimetric analysis of the stepwise mechanochemically obtained [Zr₆O₄(OH)₄(L⁴)₆](darker line) and the one-pot mechanochemically obtained [Zr₆O₄(OH)₄(L⁴)₆](lighter line).

FIG. 34 shows N₂ adsorption isotherms at 77 K were collected from the stepwise mechanochemically obtained [Zr₆O₄(OH)₄(L³)₆](adsorption (●), desorption (◯), darker circles) and the one-pot mechanochemically obtained [Zr₆O₄(OH)₄(L³)₆](adsorption (●), desorption (◯), lighter circles).

FIG. 35 shows surface area values of the stepwise mechanochemically obtained [Zr₆O₄(OH)₄(L³)₆] and the one-pot mechanochemically obtained one derived from N₂ adsorption isotherms at 77 K.

FIG. 36 shows N₂ adsorption isotherms at 77 K were collected from the stepwise mechanochemically obtained [Zr₆O₄(OH)₄(L⁴)₆](adsorption (●), desorption (◯), darker circles) and the one-pot mechanochemically obtained [Zr₆O₄(OH)₄(L⁴)₆](adsorption (●), desorption (◯), lighter circles).

FIG. 37 shows surface area values of the stepwise mechanochemically obtained [Zr₆O₄(OH)₄(L⁴)₆] and the one-pot mechanochemically obtained one derived from N₂ adsorption isotherms at 77 K.

FIG. 38 shows the ¹H NMR spectrum of [Zr₆O₄(OH)₄(L⁵)₆] digested by DCI was acquired in d₆-DMSO at 23° C. The chemical shift 5=10.28 ppm is attributed to the aldehyde proton of 2,5-dihydroxyterephthalaldehyde, while the shift 5=10.12 ppm corresponds to the aldehyde proton of terephthalaldehyde. Integration of these signals confirms a 98% exchange yield from [Zr₆O₄(OH)₄(L³)₆] to [Zr₆O₄(OH)₄(L⁵)₆].

FIG. 39 shows the ¹H NMR spectrum of the reaction mixture was acquired in d₆-DMSO at 23° C. directly after milling (without any further purifications) to obtain H₄L⁶. The integrated peaks are assigned to the desired protons of H₂L⁶.

FIG. 40 shows IR spectra (3600-400 cm⁻¹) were collected from 5-aminoisophthalic acid (bottom line), terephthalaldehyde (middle line), and the mechanochemically obtained ligand H₄L⁶ (top line).

FIG. 41 shows IR spectra (3800-400 cm⁻¹) was collected from H₄L⁶ (top line), the stepwise mechanochemically obtained [Cu₂(L⁶)](middle line), and the one-pot mechanochemically prepared [Cu₂(L⁶)](bottom line).

FIG. 42 shows plots of weight % vs. temperature were recorded by thermogravimetric analysis of the stepwise mechanochemically obtained [Cu₂(L)⁶](darker line) and the one-pot mechanochemically obtained [Cu₂(L)⁶](lighter line).

FIG. 43 shows surface area values of the stepwise mechanochemically obtained [Cu₂(L⁶)] and the one-pot mechanochemically obtained one derived from N₂ adsorption isotherms at 77 K.

FIG. 44 shows CO₂ adsorption isotherms were measured from the mechanochemically obtained [Zr₆O₄(OH)₄(L¹)₆] at 273 K (adsorption (●), desorption (0), darker circles) and at 298 K (adsorption (●), desorption (◯), lighter circles).

FIG. 45 shows virial fitting of CO₂ adsorption isotherms for [Zr₆O₄(OH)₄(L¹)₆] at 273 K (adsorption (●), data fitting (-), darker color) and at 298 K (adsorption (●), data fitting (-), lighter color).

FIG. 46 shows isosteric heat of adsorption of CO₂ for [Zr₆O₄(OH)₄(abdc)₆](darker line) and [Zr₆O₄(OH)₄(L¹)₆](lighter line) using the virial fit.

FIG. 47 shows CO₂ adsorption isotherms were measured from the mechanochemically obtained [Zr₆O₄(OH)₄(abdc)₆] at 273 K (adsorption (●), desorption (0), darker circles) and at 298 K (adsorption (●), desorption (◯), lighter circles).

FIG. 48 shows virial fitting of CO₂ adsorption isotherms for [Zr₆O₄(OH)₄(abdc)₆] at 273 K (adsorption (●), data fitting (-), darker color) and at 298 K (adsorption (●), data fitting (-), lighter color).

FIG. 49 shows PXRD patterns of the mechanochemically synthesized [Zr₆O₄(OH)₄(abdc)₆](bottom line) are consistent with the calculated ones (top line).

FIG. 50 shows PXRD patterns were collected from a series of experiments that examine the amount of the DMF additive to the mechanochemical synthesis of [Zr₆O₄(OH)₄(abdc)₆]: bottom line, η=0.75 μL/mg; middle-bottom line, η=0.90 μL/mg; middle-top line, η=1.2 μL/mg; top line, η=1.5 μL/mg. Except η=0.75 μL/mg, others provide similar PXRD patterns.

FIG. 51 shows IR spectra (3700-400 cm⁻¹) was collected from H₂(abdc) (bottom line) and the mechanochemically obtained [Zr₁₂O₄(OH)₄(abdc)₆](top line).

FIG. 52 shows a plot of weight % vs. temperature was recorded by thermogravimetric analysis of the mechanochemically obtained [Zr₆O₄(OH)₄(abdc)₆].

FIG. 53 shows N₂ adsorption isotherm at 77 K was collected from the mechanochemically obtained [Zr₆O₄(OH)₄(abdc)₆](adsorption (●), desorption (◯)).

FIG. 54 shows surface area values of the mechanochemically obtained [Zr₆O₄(OH)₄(abdc)₆] derived from N₂ adsorption isotherms at 77 K.

FIG. 55A includes photographs and chemical structures showing the synthesis of imine-UiO MOFs (and a particular MOF referred to therein as PCN-161).

FIG. 55B includes a plurality of graphs showing the characterization of PCN-161.

FIG. 55C includes a plurality of graphs showing a generalization of mechanochemical synthesis.

FIG. 55D includes a plurality of schemata and graphs showing post-synthetic modifications.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

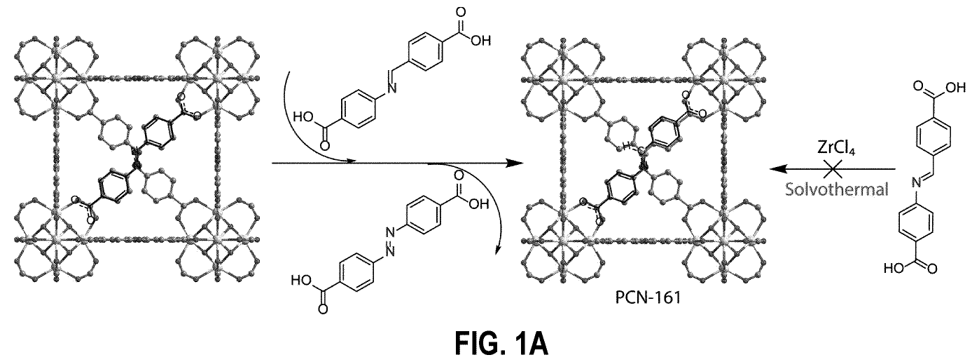

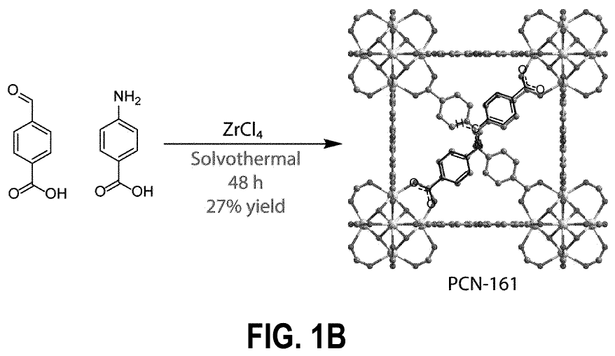

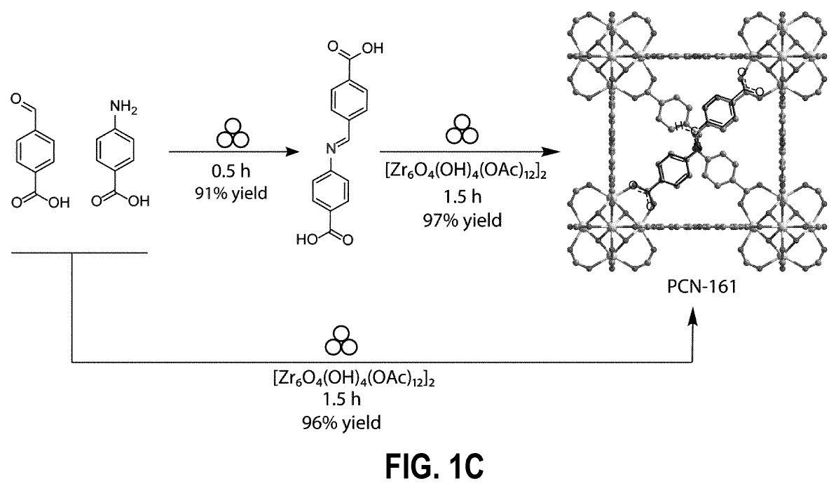

In the various aspects of the present invention, the present inventors not only leverage mechanochemical synthesis as a productive strategy to successfully introduce imine-based ligands into MOFs, but also unlock the power of solid-state tandem reaction, which allows for both ligand synthesis and the growth of MOF lattices simultaneously without isolating any intermediates (FIG. 1C). This work not only leverages the mechanochemical synthesis at ambient temperature to achieve the efficient imine linker introduction, but also unlocks the powder of solid-state tandem reaction allowing for the ligand synthesis and MOF growth simultaneously. Mechanochemistry proves to be highly generalizable with high yield. And so, the demonstrated mechanochemistry, a highly generalizable synthetic strategy, opens up new chemical space, where an extended family of imine-based MOFs rarely encountered can be immediately obtained.

One aspect of the present invention is directed to a MOF, where the MOF is comprised of a linker molecule and a metal cluster. In this aspect, a MOF is comprised of a linker molecule and a metal cluster, wherein the linker molecule comprises an imine group and a linking moiety and the metal cluster comprises a plurality of metal atoms bound to oxygen atoms. The metal cluster is configured to coordinate with the linking moiety of the MOF.

In various embodiments of this aspect of the invention, the MOF comprises a plurality of linker molecules.

In various embodiments of this aspect of the invention, the MOF comprises a plurality of metal clusters. Further, the MOF comprising a plurality of metal cluster further comprises a plurality of linker molecules.

In a further embodiment of this aspect of the invention, each linker molecule comprises a plurality of linking moieties, wherein each linker molecule is connected to multiple metal clusters.

In a further embodiment of this aspect of the invention, each metal cluster is connected to greater than or equal to 4 linking molecules and less than or equal to 12 linking molecules.

Further, in various embodiments each metal cluster can be connected to 12 linking molecules, and the plurality of metal atoms comprises zirconium, hafnium, or combination thereof.

In further embodiment, each metal cluster is connected to 4 linking molecules, wherein the plurality of the metal atoms comprises copper.

In various embodiments of this aspect of the invention, the linker molecule comprises a plurality of linking moieties. Further, the linker molecule comprises a first end and a second end, wherein the first end comprises the linking moiety and the second end comprises a second linking moiety. And the first end further comprises a third linking moiety and the second end further comprises a fourth linking moiety.

In various embodiments of this aspect of the invention, the plurality of metal atoms comprises zirconium, hafnium, or copper, or combinations thereof.

In various embodiments of this aspect of the invention, the plurality of metal atoms has an oxidation state selected from the list consisting of 2+ and 4+.

In various embodiments of this aspect of the invention, each mental atom is coordinated with greater than or equal to eight oxygen groups.

In further various embodiments, the linker molecule is a ditopic linker molecule consisting of only two linking moieties. In other embodiments, the linker molecule is a tetratopic linker molecule consisting of only four linking moieties. The linker molecule can be selected from a group consisting of a carboxylic acid group, a pyridine group, and an azole group.

In various embodiments, there may be at least two linking moieties. And a linking moiety (first linking moiety) is selected from the group consisting of a carboxylic acid group, a pyridine group, and an azole group, and a second linking moiety is different than the first linking moiety. Other embodiments may include a third linking moiety, wherein the linking moiety (first linking moiety) and a third linking moiety are the same and selected from the group consisting of a carboxylic acid group and a pyridine group. Another embodiment may include a fourth linking moiety. In such an embodiment, the second linking moiety and the fourth linking moiety are the same and are different from the first linking moiety and the third linking moiety.

In other embodiments, the linking moiety and the second linking moiety are the same and are selected from a group consisting of a carboxylic acid, a pyridine group, and the third linking moiety and the fourth linking moiety are the same and different from the first linking moiety and the second linking moiety.

In various embodiments, then, an MOF is produced wherein the first end comprises a first aromatic ring and the first linking moiety as a functional group attached thereto, and wherein the second end comprises a second aromatic ring comprising the second linking moiety as a function group attached thereto. Further, the first aromatic ring can be a benzene ring, and the second aromatic ring can be a benzene ring, wherein each benzene ring comprises a first carbon opposite a fourth carbon, a second carbon opposite a fifth carbon, and a third carbon opposite a sixth carbon, and wherein each carbon is adjacent to sequentially numbered carbons, wherein the first carbon is adjacent to the sixth carbon.

In further embodiments, the first aromatic ring and second aromatic ring can be connected by a carbon chain. And the carbon chain can comprise a first portion connected to the first aromatic ring, a second portion connected to the second aromatic ring, and the imine group, wherein the imine group connects the first portion and the second portion of the carbon chain.

Further, in certain embodiments, the first aromatic benzene ring comprises the carbon chain connected to the first carbon, and the linking moiety connected to the fourth carbon, and the second aromatic benzene ring comprises the carbon chain connected to the first carbon, and the second linking moiety connected to the fourth carbon.

In a further embodiment, the first aromatic ring and second aromatic ring are connected via a carbon chain, the carbon chain comprises a branch not used to connect the first aromatic ring and the second aromatic ring, and the branch comprises the imine group.

In a further embodiment of the MOF, the first end comprises a first aromatic ring comprising the first linking moiety and third linking moiety as functional groups attached thereto, and the second end comprises a second aromatic ring comprising the second linking moiety and the fourth linking moiety as functional groups attached thereto.

In a further embodiment of the MOF, the first aromatic ring is a benzene ring, and the second aromatic ring is a benzene ring, wherein each benzene ring comprises a first carbon opposite a fourth carbon, a second carbon opposite a fifth carbon, and a third carbon opposite a sixth carbon, and wherein each carbon is adjacent to sequentially numbered carbons, and wherein the first carbon is adjacent to the sixth carbon.

In a further embodiment of the MOF, the first aromatic ring and second aromatic ring are connected via a carbon chain, with the carbon chain comprising a first portion connected to the first aromatic ring, a second portion connected to the second aromatic ring, and the imine group, wherein the imine group connects the first portion and the second portion of the carbon chain.

In a further embodiment, the first aromatic benzene ring comprises the carbon chain connected to the first carbon, the linking moiety connected to the third carbon, and the third linking moiety connected to the fifth carbon. And, the second aromatic benzene ring comprises the carbon chain connected to the first carbon and the second linking moiety connected to the third carbon and the fourth linking moiety connected to the fifth carbon.

In a further embodiment of the MOF, the first aromatic ring and second aromatic ring are connected via a carbon chain, the carbon chain comprises a branch not used to connect the first aromatic ring and the second aromatic ring, and the branch comprises the imine group.

Another aspect of the present invention is directed to amechanochemical method of synthesizing an MOF. The mechanochemical method comprises linking at least two metal clusters using at least one linking molecule by applying mechanochemical force. Further, the linking molecule comprises a first aromatic ring and a second aromatic ring, and each aromatic ring contains at least one linking moiety as a function group attached thereto. Each linking moiety is configured to coordinate with at least two metal clusters and an amine group. Each metal cluster comprises a plurality of metal atoms bound to oxygen atoms. And each metal cluster is configured to coordinate with the linking moiety.

In one embodiment of this aspect of the invention, each linking moiety is selected from the group consisting of a carboxylic acid group, a pyridine group, an azole group, or a combination thereof. Further, in various embodiments, each linking moiety is a ditopic, tritopic, or tetratopic linker, or combinations thereof. In a further embodiment of the mechanochemical method, the plurality of aromatic rings is connected via a carbon chain comprising the imine group. And, the imine group can be positioned in a branch of the carbon chain, wherein the branch does not connect the plurality of aromatic rings. Additionally, the carbon chain can comprise a first portion connected to a first aromatic ring, and a second portion connected to a second aromatic ring. The second portion can be connected to the first portion via the imine group.

In a further embodiment of this aspect of the invention, the carbon chain further comprises a second imine group and a third aromatic ring, the first aromatic ring is connected to a first portion of the carbon chain, the first portion of the carbon chain is connected to the imine group, the imine group is connected to the third aromatic ring, the third aromatic ring is connected to the second imine group, the second imine group is connected to a second portion of the carbon chain, and the second portion of the carbon chain is connected to the second aromatic ring.

In a further embodiment of this aspect of the invention, applying mechanochemical force comprises the use of a mechanochemical agitation system selected from the list consisting of ball mill, a mixer mill, a grinding mill, an extruder mill, a rotating drum mill, and a combination thereof.

In a further embodiment of this aspect of the invention, applying the mechanochemical force comprises the use of mixing balls or does not comprise the use of mixing balls.

In a further embodiment of this aspect of the invention, applying mechanochemical force is completed in less than or equal to 12 hours. Alternatively, applying mechanochemical force is completed in less than or equal to 6 hours. In another alternative, applying mechanochemical force is completed in less than or equal to 2 hours.

In a further embodiment of this aspect of the invention, the mechanochemical method further comprises forming the linking molecule from a first linking molecule portion comprising the first aromatic ring and a second linking molecule portion comprising the second aromatic ring.

In a further embodiment of this aspect of the invention, forming the linking molecule occurs simultaneously with linking the at least two metal clusters using at least one linking molecule via the simultaneous application of mechanochemical force to the at least two metal clusters, the first linking molecule portion, and the second linking molecule portion.

In a further embodiment of this aspect of the invention, forming the linking molecule occurs in a preliminary reaction step prior to linking the at least two metal clusters using the at least one linking molecule.

In a further embodiment of this aspect of the invention, the preliminary reaction step comprises the application of mechanochemical force to the first linking molecule portion and the second linking molecule portion.

In a further embodiment of this aspect of the invention, the preliminary reaction step does not comprise the use of any solvent.

In a further embodiment of this aspect of the invention, the linking step comprises the use of solvent.

In a further embodiment of this aspect of the invention, the ratio of solvent volume to a combined mass of the linker molecules and metal clusters is greater than or equal to 0.6 μL/mg and less than or equal to 40 μL/mg. In an alternative embodiment, the ratio of solvent volume to a combined mass of the linker molecules and metal clusters is greater than or equal to 0.6 μL/mg and less than or equal to 10 μL/mg. In yet a further embodiment, the ratio of solvent volume to a combined mass of the linker molecules and metal clusters is greater than or equal to 0.6 μL/mg and less than or equal to 1.5 μL/mg. And in still a further embodiment, the ratio of solvent volume to a combined mass of the linker molecules and metal clusters is greater than or equal to 0.6 μL/mg and less than or equal to 1.05 μL/mg.

In a further embodiment of this aspect of the invention, the solvent is selected from the list consisting of N,N-dimethylformamide (DMF), N,N-Dimethylacetamide (DMA), ethanol, methanol, acetone, acetonitrile, or a combination thereof.

In a particular embodiment of this aspect of the invention, the solvent is DMF.

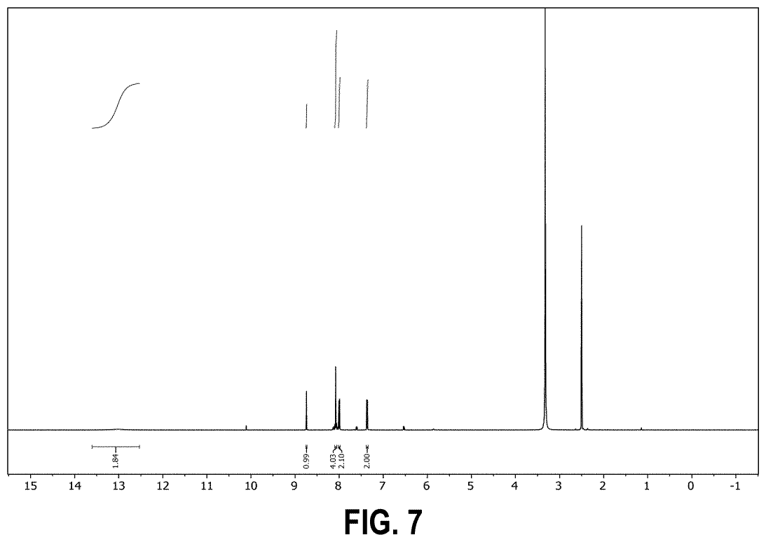

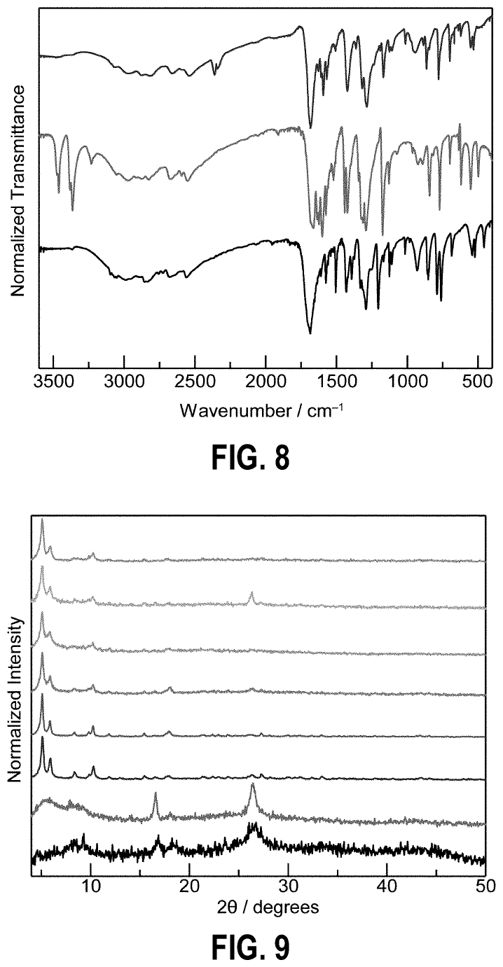

The various aspects and embodiments are described further with respect to studies and experiments performed by the present inventors. In that regard, the present inventors initiated studies by examining if mechanochemistry could serve as a viable tool to synthesize 4-[(E)-(4-carboxybenzylidene)amino]benzoic acid (H₂L¹) featuring the moiety of a Schiff base as its backbone. Milling 4-aminobenzoic acid and 5-formylbenzoic acid in a 1:1 molar ration using a shaker-type mill at 25 Hz for 30 min under neat conditions provided the desired product with a yield of 91%, validated by 1H NMR (FIG. 7). The delivery of H₂L¹ was also confirmed by high-resolution electrospray-ionization mass spectrometry, which provided a value of m/z that corresponded to [HL¹]⁻. Infrared (IR) spectroscopy (FIG. 8) supported the formation of the imine group, as evidenced by the disappearance of N—H stretches between 3480 cm⁻¹ and 3360 cm⁻¹, characteristic of the primary amine group. Changing the milling frequency from 25 Hz to 30 Hz or the milling time to 45 min does not affect the reaction yield significantly (as shown in Table 1, which appears in Example 1, below).

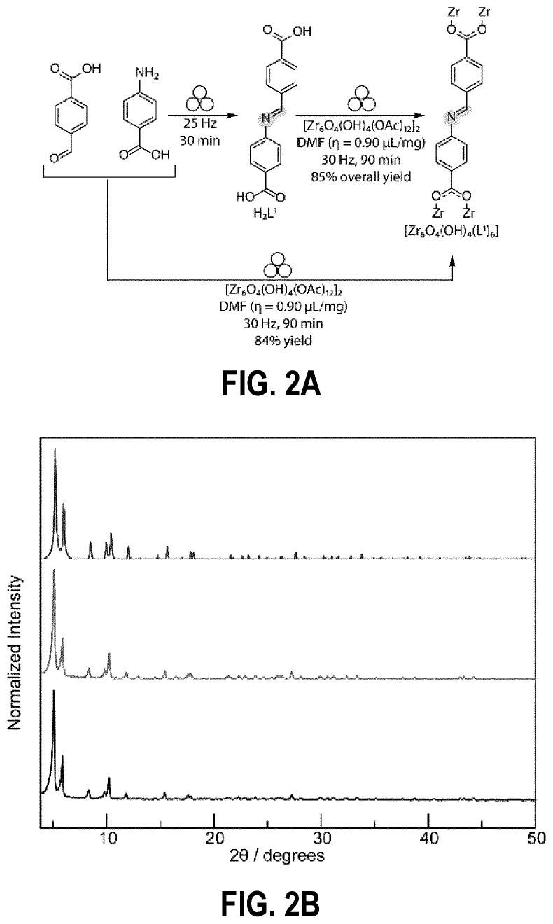

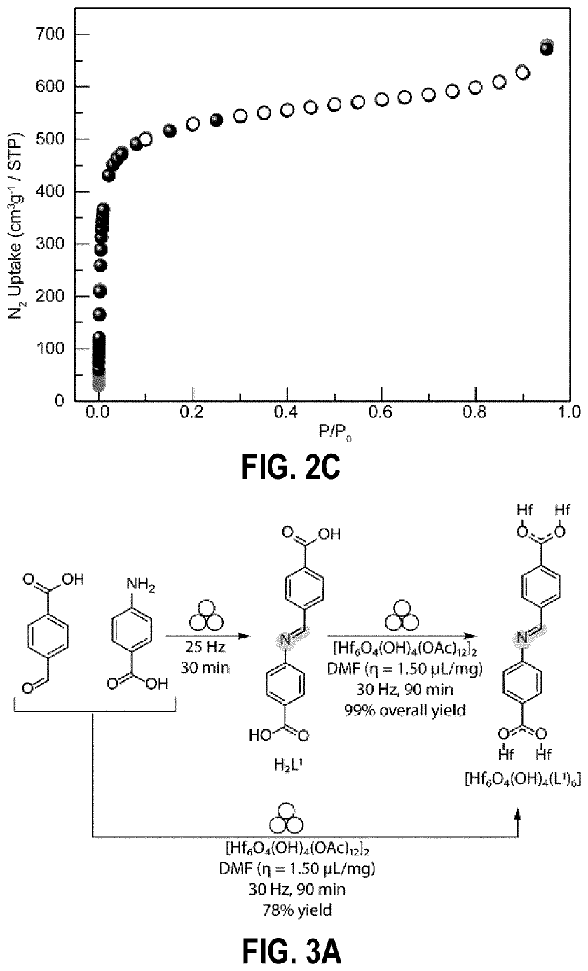

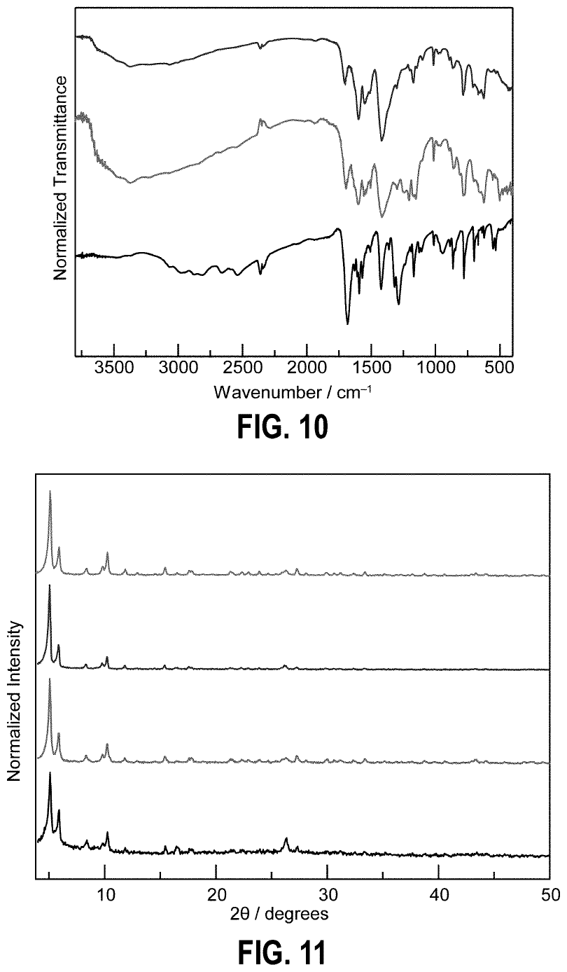

Following the success of mechanochemical preparation for the imine-based H₂L¹, the present inventors explored the solid-state synthesis of [Zr₆O₄(OH)₄(L¹)₆], also known as PCN-161, an extended analogue of UiO-66 with an fcu topology, [J. H. Cavka, S. Jakobsen, U. Olsbye, N. Guillou, C. Lambed, S. Bordiga, P. Lillerud, J. Am. Chem. Soc. 2008, 130, 13850-13851], which is based on the above mechanochemically prepared H₂L¹ near-linear ligand and [Zr₆O₄(OH)₄(OAc)₁₂]₂ (FIG. 2A). The zirconium molecular complex, a precursor for mechanochemical synthesis, was obtained in advance by reacting zirconium(IV) propoxide with acetic acid [B. Karadeniz, A. J. Howarth, T. Stolar, T. Islamoglu, I. K. Uzarevic, M. Tireli, M. C. Wasson, S.-Y Moon, O. K. Farha, T. Friscic, Uzarevic, ACS Sustain. Chem. Eng. 2018, 6, 15841-15849]. After a series of attempts on tuning additive liquid (FIG. 9), the optimized reaction condition to prepare [Zr₆O₄(OH)₄(L¹)₆] is milling a mixture of H₂L¹ and [Zr₆O₄(OH)₄(OAc)₁₂]₂ in a molar ratio of 12:1 in the presence of N,N-dimethylformamide (DMF, η=0.90 μL/mg) at 30 Hz for 90 min. Such nearly solid-state synthesis exhibits sustainable advantages of short reaction time and solvent volume reduction, compared to the conventional solvothermal method. The reaction yield is calculated to be 85%, significantly higher than the one of 27% reported in the solvothermal study. Meanwhile, the rapid formation of MOF lattice at ambient temperature along with minimal solvent effectively avoids the hydrolysis of imine—a decomposition pathway to its precursors, which has imposed a synthetic barrier in the direct solvothermal reaction. The obtained crystalline phase was confirmed by powder X-ray diffraction (PXRD), which generated patterns in agreement with the calculated ones (FIG. 2B). The reaction completeness was monitored by IR spectroscopy (FIG. 10), which indicates the disappearance of carbonyl stretch at 1683 cm⁻¹ and C—O stretch at 1285 cm⁻¹ from free carboxylic acid of H₂L¹ accompanied by the new broad strong peak at 1412 cm⁻¹ assigned to the coordinated carbonyl stretch.

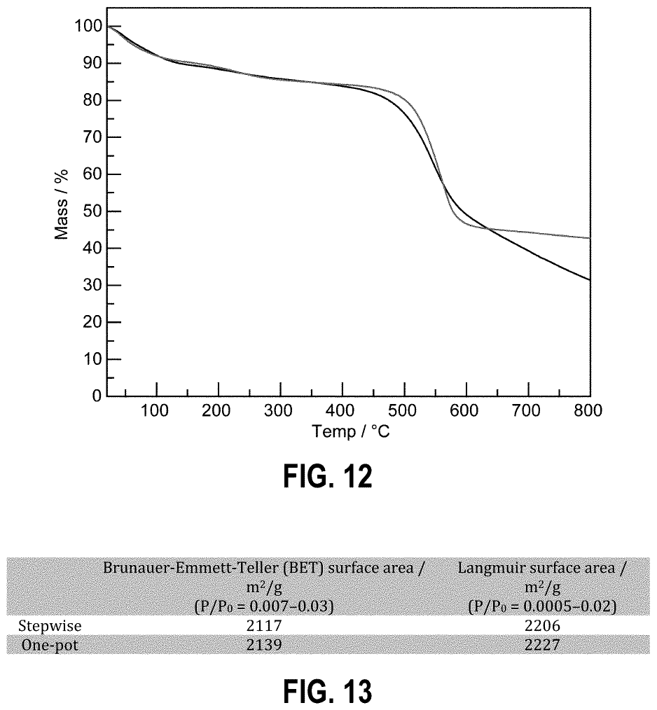

Since both imine formation and ligand substitution had been successfully achieved through mechanochemistry individually, the present inventors then integrated these two steps into a single process. Thus, a mechanochemical cascade reaction was attempted by milling 4-formalbenzoic acid, 4-aminobenzoic acid, and [Zr₆O₄(OH)₄(OAc)₁₂]₂ using a stoichiometric ratio of 12:12:1 in the company of DMF (η=0.90 μL/mg, FIG. 11) in one pot at 30 Hz for 90 min. This single tandem reaction also delivered the crystalline phase of [Zr₆O₄(OH)₄(L¹)₆] with a yield of 84%, confirmed by PXRD analysis (FIG. 2B). The IR spectrum collected from the one-pot product (FIG. 10) shows the same absorption peaks as the stepwise one. Thermogravimetric analysis (TGA), carried out on both samples (FIG. 12) prepared by the stepwise and tandem reactions, shows the same thermal behavior. An initial weight loss of ˜14% corresponding to solvent and guest molecules trapped in the cavities was observed between 23° C. and 250° C. Then a plot plateau until 450° C. accounts for the thermal stability of this MOF, followed by the collapse of the framework at higher temperature.

Thus, these mechanochemically prepared samples were activated under vacuum at 120° C. for 18 h prior to gas adsorption analysis. Nitrogen adsorption isotherms for both stepwise and one-pot obtained [Zr₆O₄(OH)₄(L¹)₆] samples were measured at 77 K, shown in FIG. 2C. The stepwise prepared [Zr₆O₄(OH)₄(L¹)₆] exhibits a Brunauer-Emmett-Teller (BET) surface area of 2117 m²/g (P/P₀=0.007-0.03), while the one-pot sample achieves a comparable BET surface area of 2139 m²/g (P/P₀=0.007-0.03). Those consistent surface area values demonstrate that the mechanochemical synthesis of [Zr₆O₄(OH)₄(L¹)₆], whether performed stepwise or in one-pot, yields porous materials of similar quality. [A slightly higher surface area of the solvothermally synthesized PCN-161 was reported by the employment of supercritical carbon dioxide activation.]

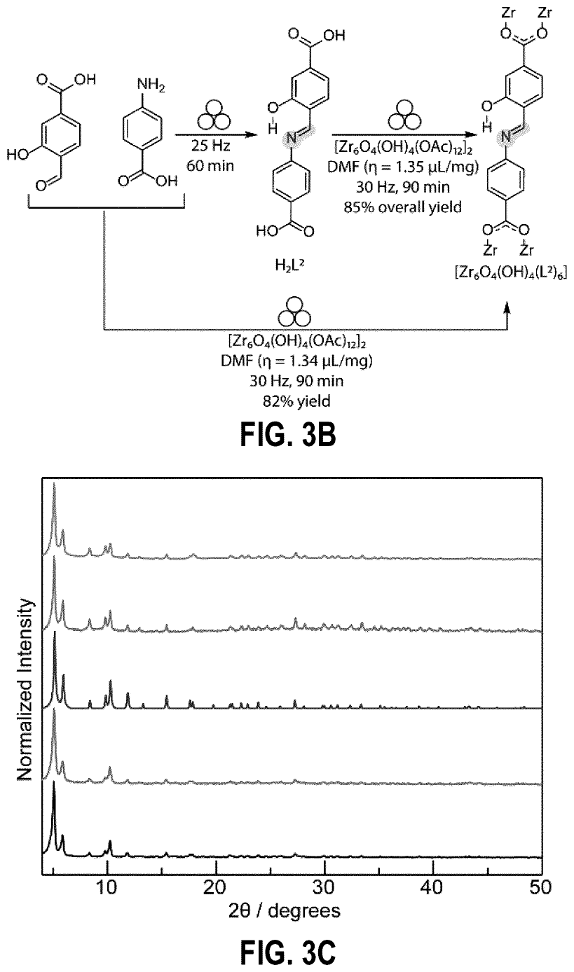

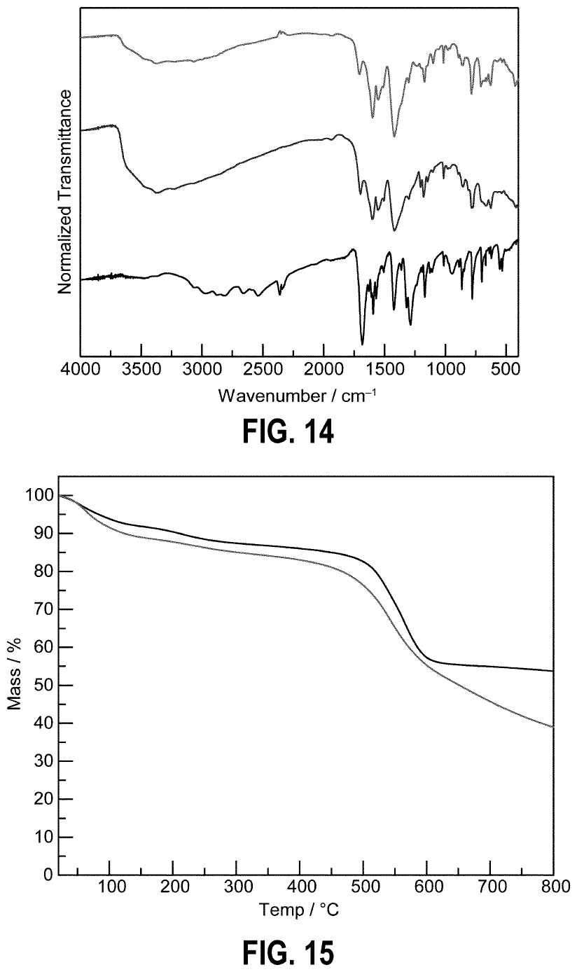

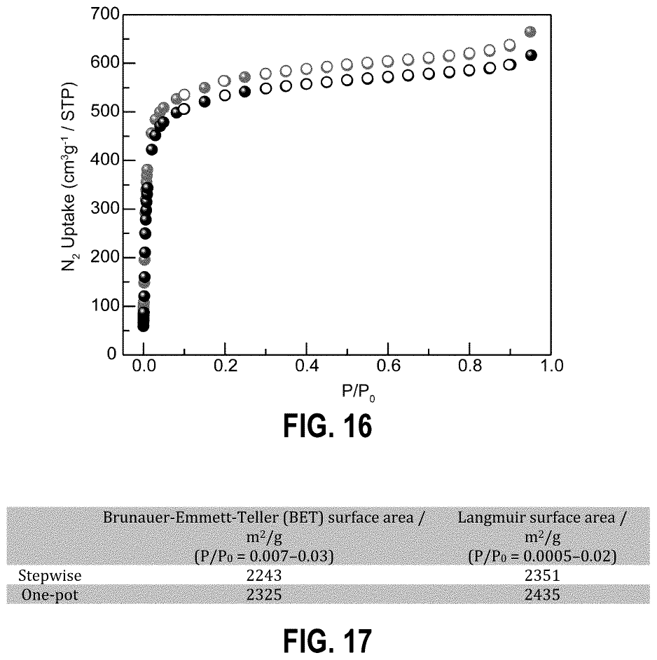

The mechanochemistry developed by the present inventors proves to be a highly generalizable approach to building a versatile family of MOFs utilizing the imine as the ligand strut. For example, the Hf analogue of PCN-161, [Hf₆O₄(OH)₄(L¹)₆](FIG. 3A), becomes readily accessible via both stepwise (99% overall yield) and tandem reactions (78% yield) using [Hf₆O₄(OH)₄(OAc)₁₂]₂ as the milling precursor. The two MOF products synthesized by two different approaches, demonstrate similar features observed in PXRD patterns (FIG. 3C), IR spectra (FIG. 14), TGA plots (FIG. 15), and N₂ adsorption isotherms at 77 K (FIGS. 16-17). As far as is known, this is the first example of Hf-based MOFs that incorporates the functional motif of a Schiff base.

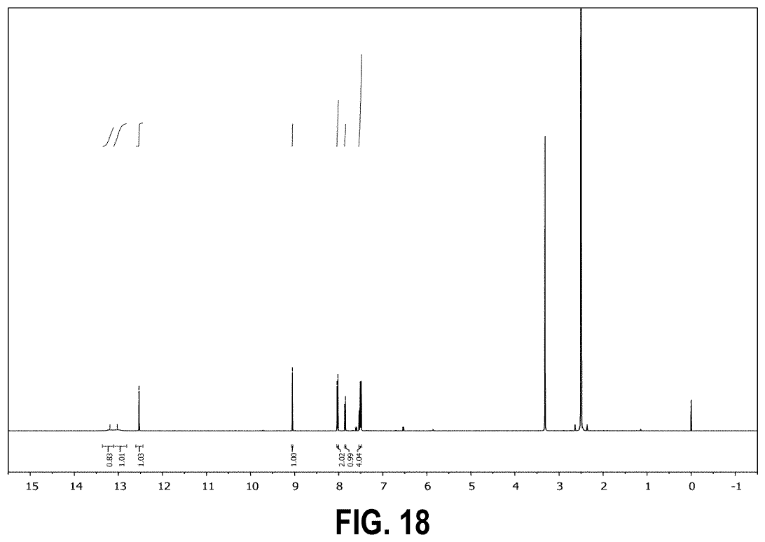

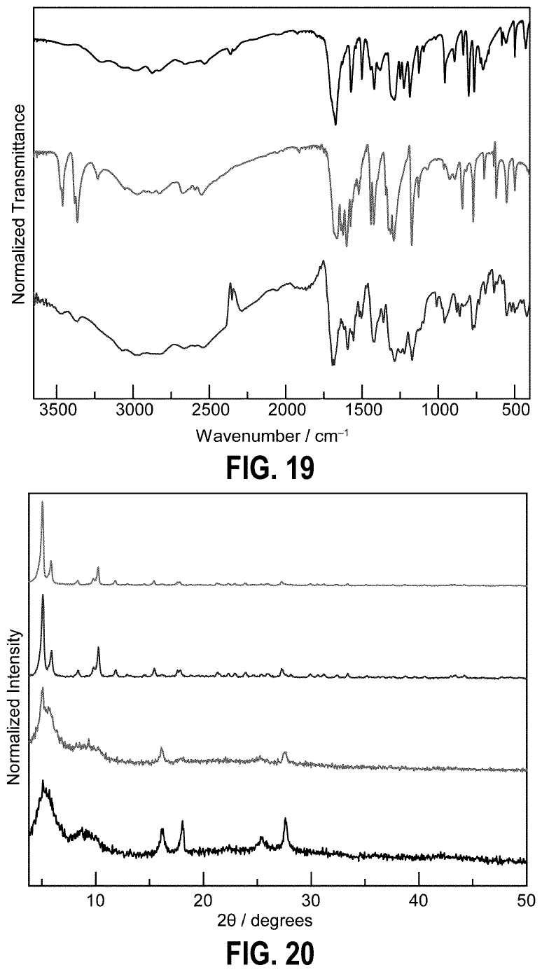

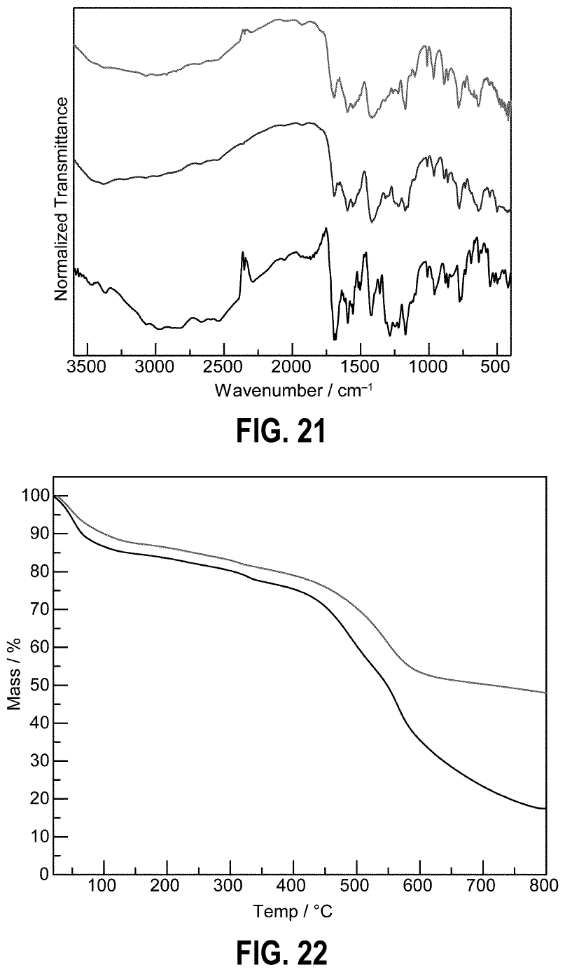

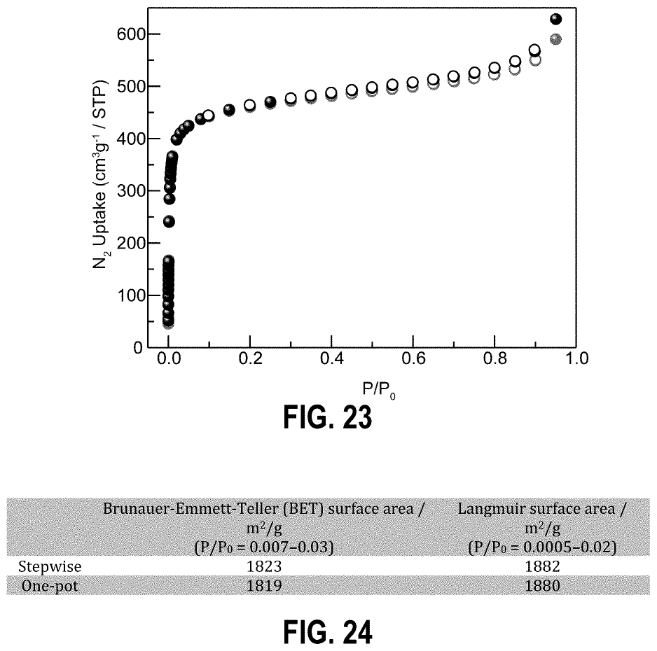

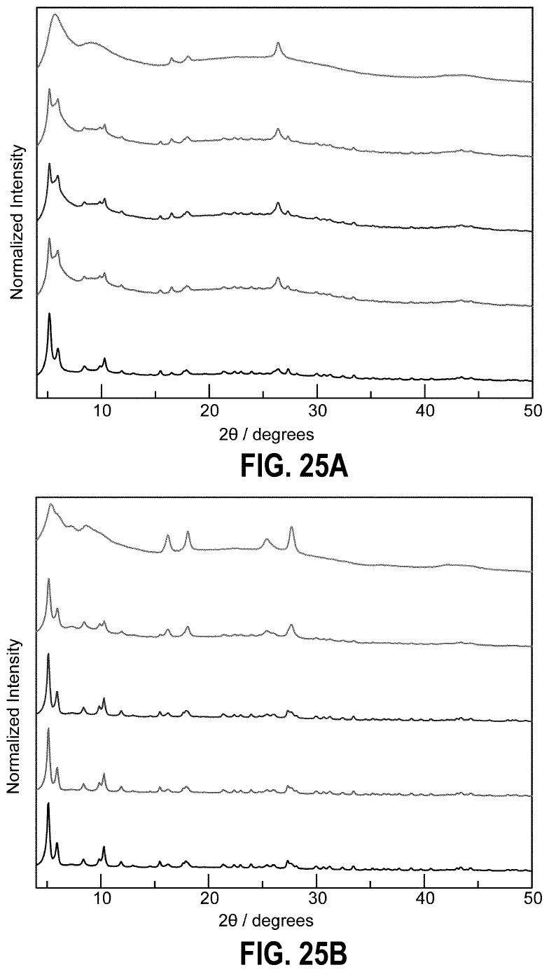

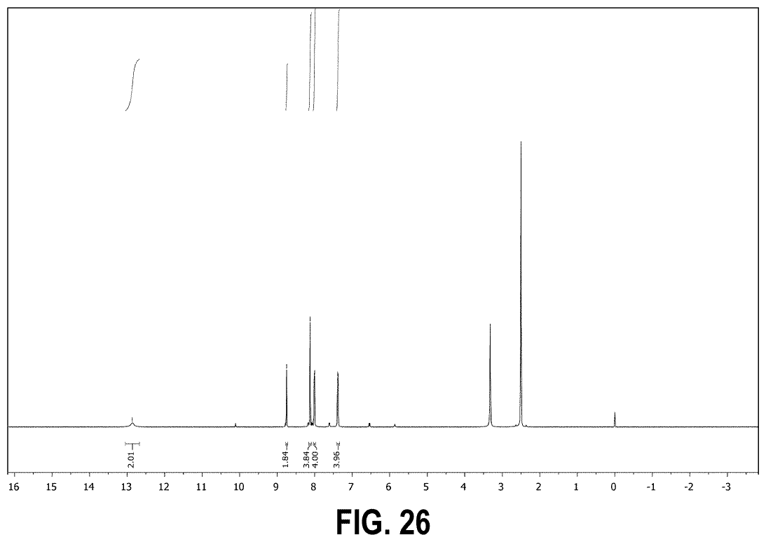

Meanwhile, the immediate ligand derivative is 4-[[(4-carboxyphenyl)imino]methyl]-3-hydroxybenzoic acid (H₂L², FIG. 3B), which is made by replacing 4-formylbenzoic acid by 4-formally-3-hydroxybenzoic acid with an NMR yield of 94% (FIG. 18) during the milling. This compound was also verified by high-resolution mass spectrometry (HRMS) and characterized by IR (FIG. 19). Similarly, this has enabled mechanochemical access to [Zr₆O₄(OH)₄(L²)₆](FIG. 3B) by milling 4-formyl-3-hydroxybenzoic acid, 4-aminobenzoic acid, and [Zr₆O₄(OH)₄(OAc)₁₂]₂ stepwise (85% overall yield) or in one pot (82% yield), confirmed by PXRD (FIGS. 3C and 20) and IR (FIG. 21). The direct mechanochemical synthesis achieves a significantly higher yield compared to the 19% yield obtained via the solvothermal reaction [as seen in U. S. F. Arrozi, V. Bon, S. Krause, T. Liibken, M. S. Weiss, I. Senkovska, S. Kaskais, Inorg. Chem. 2020, 59, 350-359.] Other characterizations including TGA (FIG. 22), and N₂ adsorption isotherms at 77 K (FIGS. 23-24) have been performed on both MOF samples. It is worth noting that [Zr₆O₄(OH)₄(L²)₆] exhibits relatively higher moisture stability than [Zr₆O₄(OH)₄(L¹)₆], when they were exposed to air with a humidity of ˜55%. PXRD patterns (see FIGS. 25A and 25B) indicate significant peak broadening was observed with [Zr₆O₄(OH)₄(L¹)₆] exposed to air for 1 h, in contrast to [Zr₆O₄(OH)₄(L²)₆] maintaining its crystallinity in air for at least 8 h. This is attributed to the hydroxyl group within L² ligand stabilizing the most degradable motif—imine—by forming a 6-membered intramolecular hydrogen bonding ring. The enhanced stability of the imine via hydrogen bonding is consistent with previous observations in other materials.

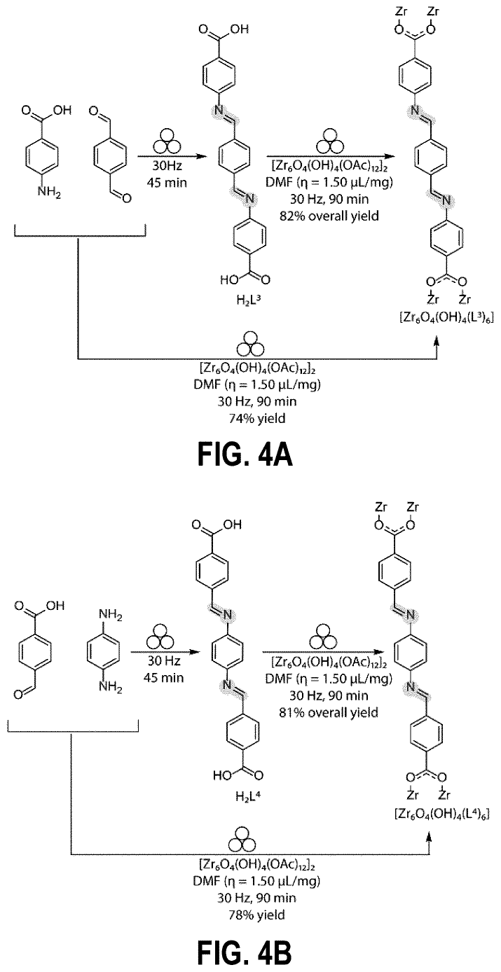

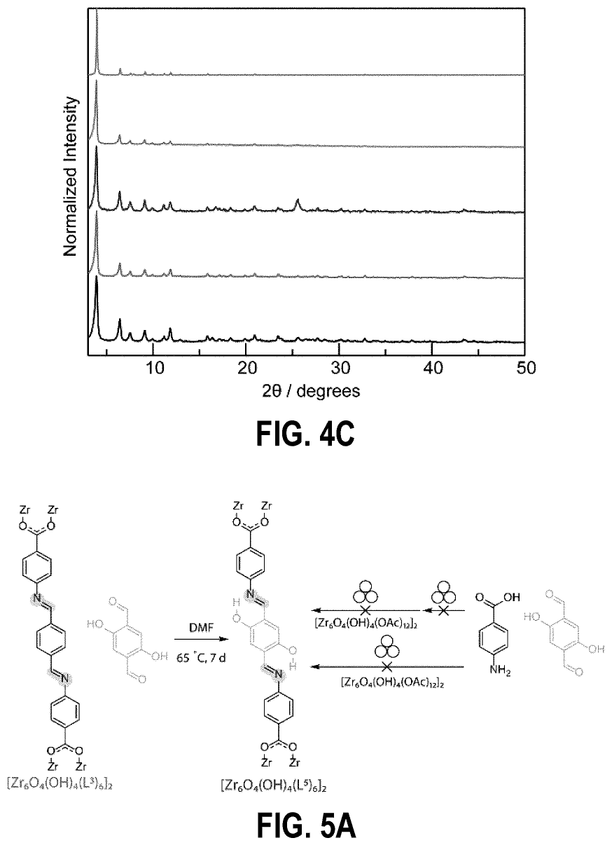

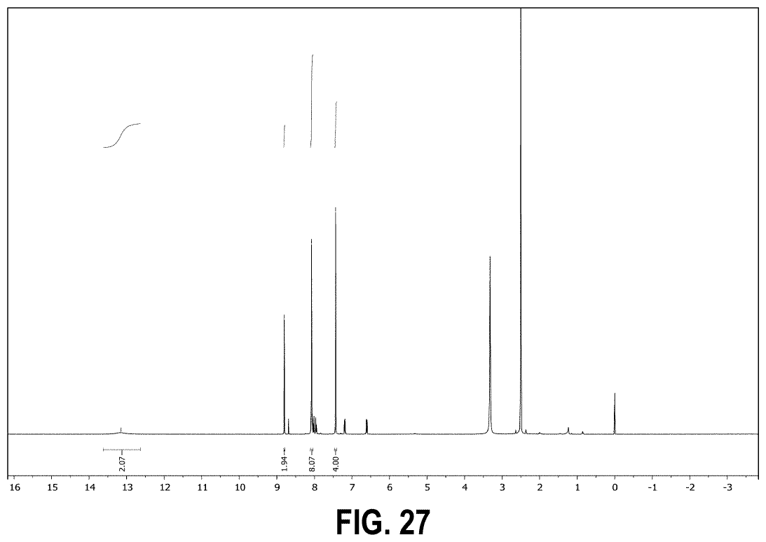

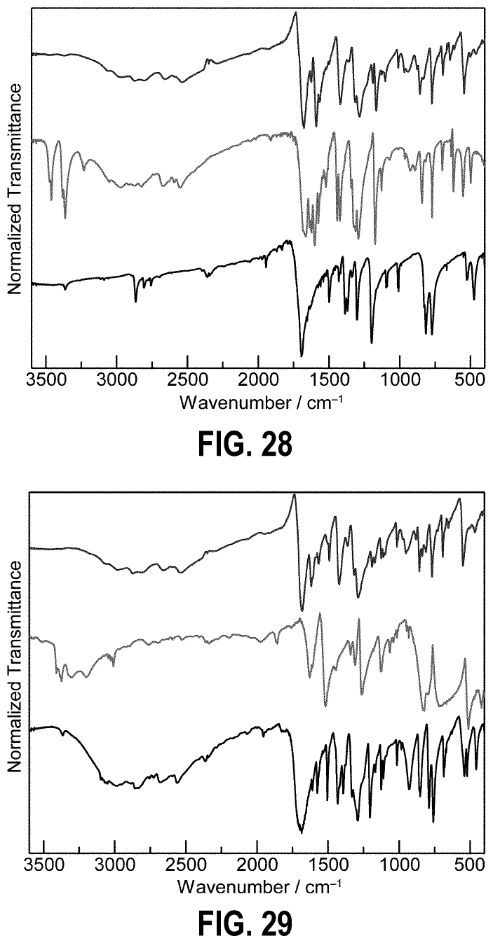

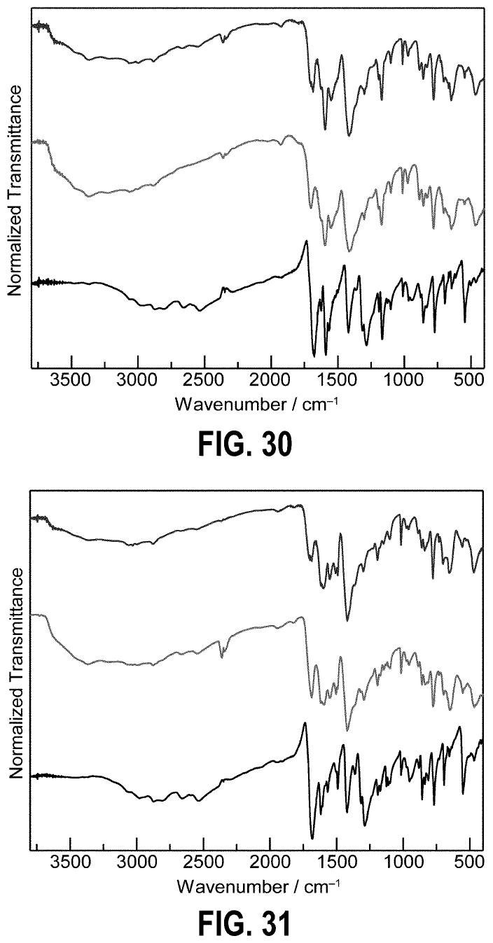

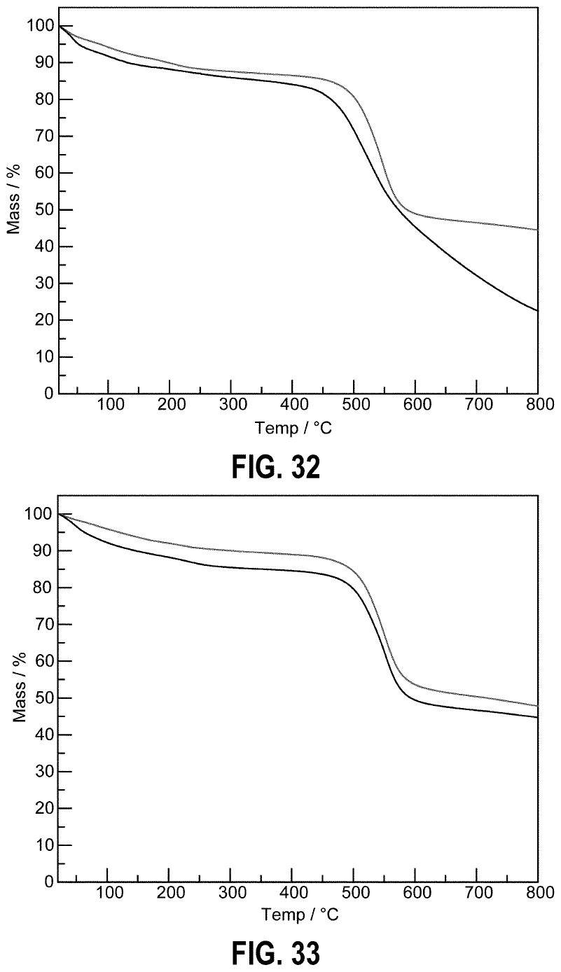

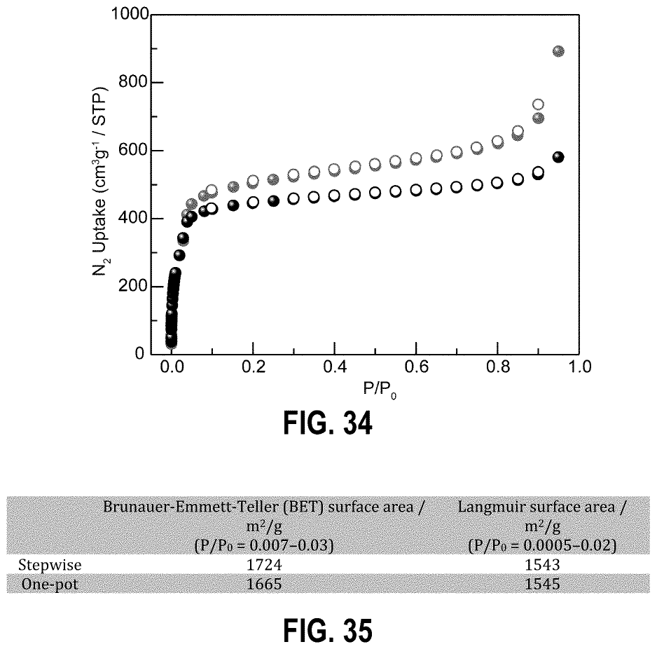

Two additional Zr-based MOFs (FIG. 4A), [Zr₆O₄(OH)₄(L³)₆](H₂L³=4,4′-phenylenebis(methylidynenitrilo)]bis[benzoic acid]) and [Zr₆O₄(OH)₄(L⁴)₆](H₂L⁴ 4,4′-[1,4-phenylenebis(nitrilomethylidyne)]bis[benzoic acid]), were also made possible by the developed mechanochemical strategy]. Amongst them, H₂L³ was obtained by milling 4-aminobenzoic acid and terephthalaldehyde in a molar ratio of 2:1 at 25 Hz for 45 min with a yield of 92% (FIG. 26). Milling 4-formylbenzoic acid and 1,4-phenylenediamine under the same conditions delivered H₂L⁴ (FIG. 27). In these two cases, each ligand contains two imine motifs enabled by facile mechanochemistry (See IR spectra in FIGS. 28-29 and HRMS). Both stepwise and tandem mechanochemical synthesis prove effective and efficient to deliver [Zr₆O₄(OH)₄(L³)₆] and [Zr₆O₄(OH)₄(L⁴)₆]. Full characterizations using PXRD (FIG. 4), IR (FIGS. 30-31), TGA (FIGS. 32-33), and N₂ adsorption analysis (FIGS. 34-37) were employed to confirm the deliveries of desired MOF materials. The straightforward and generalizable mechanochemical synthesis, extending from the initial [Zr₆O₄(OH)₄(L¹)₆] to others, highlights the features of programmability and predictability of the solid-state milling process. This is a significant departure from solvothermal chemistry, which often requires extensive explorations on experimental conditions and exquisite control over the specific reaction.

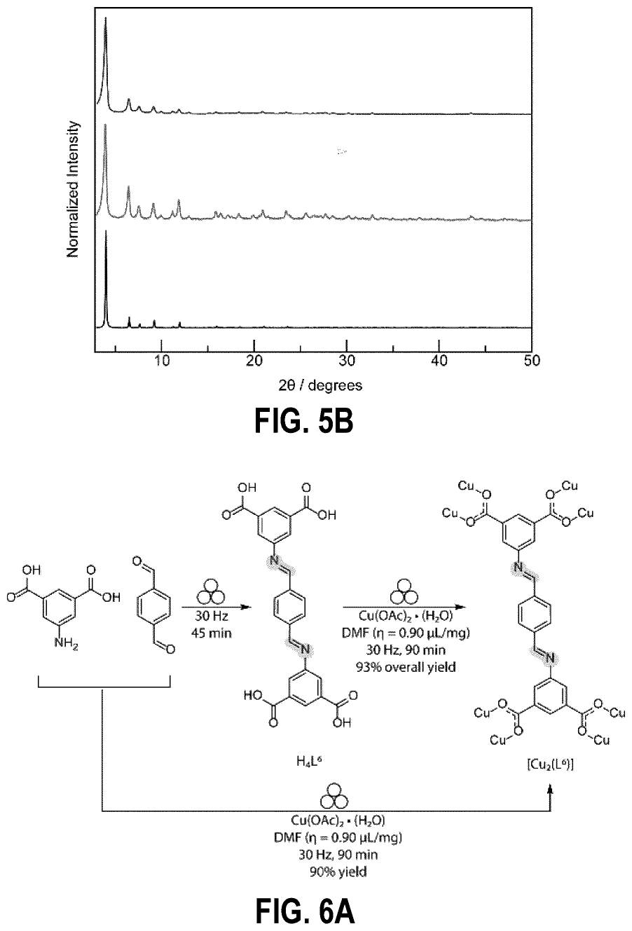

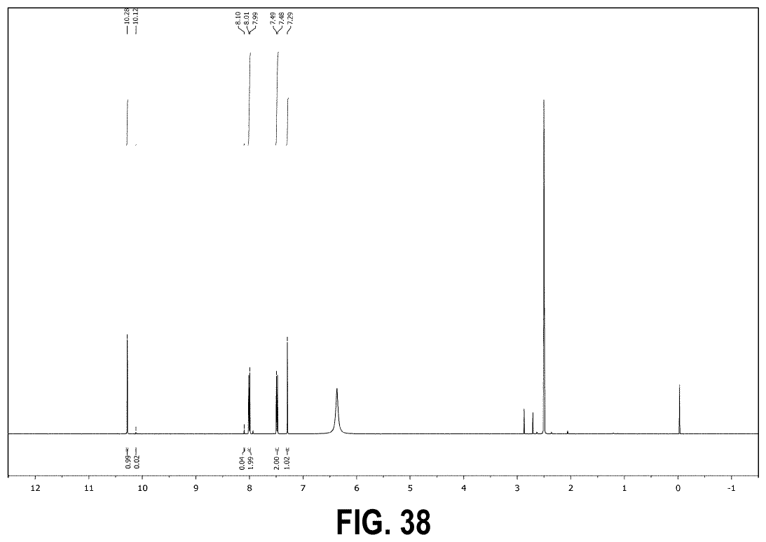

Although the present inventors were not able to directly synthesize [Zr₆O₄(OH)₄(L⁵)₆], a previously unknown MOF but isotopological to UiO-66, using 4-amniobenzoic acid, 2,5-dihydroxterephthalaldehyde, and [Zr₆O₄(OH)₄(OAc)₁₂]₂ stepwise or in one pot, the previously obtained [Zr₆O₄(OH)₄(L³)₆] enabled the present inventors to access [Zr₆O₄(OH)₄(L⁵)₆] via a ligand exchange strategy considering the dynamic imine bonding (FIG. 5A). The crystalline phase of [Zr₆O₄(OH)₄(L⁵)₆] was confirmed by PXRD (FIG. 5B and consistent with [Zr₆O₄(OH)₄(L³)₆]. Meanwhile, the NMR spectrum (FIG. 38) collected on the [Zr₆O₄(OH)₄(L⁵)₆] sample digested by acid indicated 98% of the initial unit has been successfully replaced by the dihydroxyl one. This represents an intriguing perspective of the imine motif, which is highly modular and functionalizable.

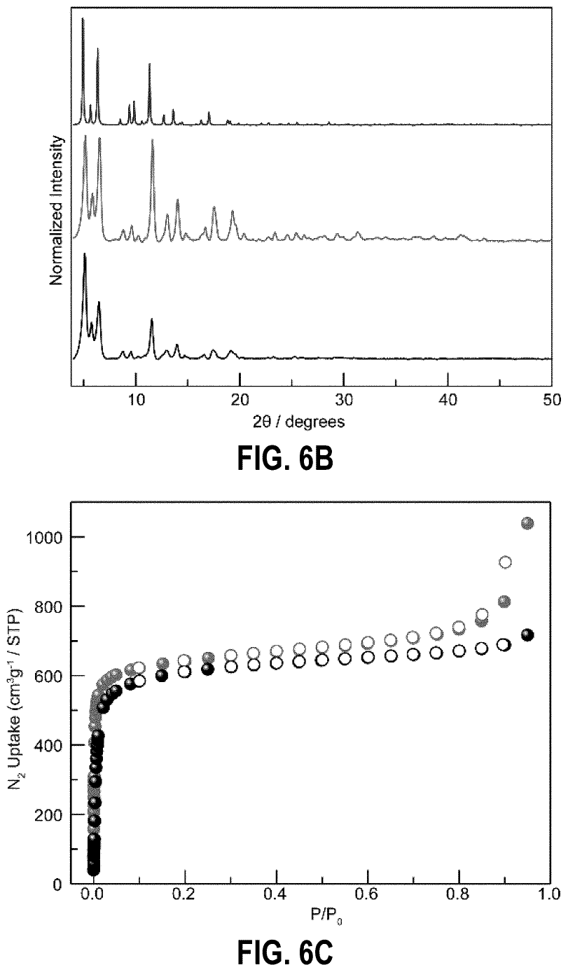

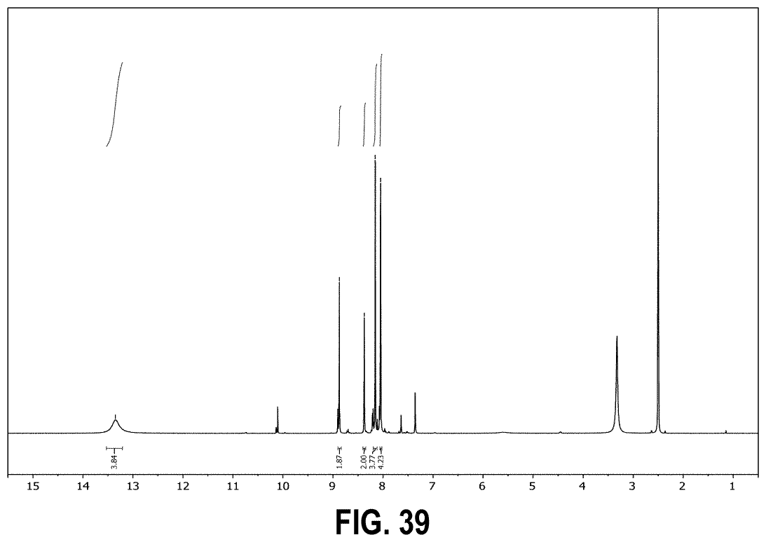

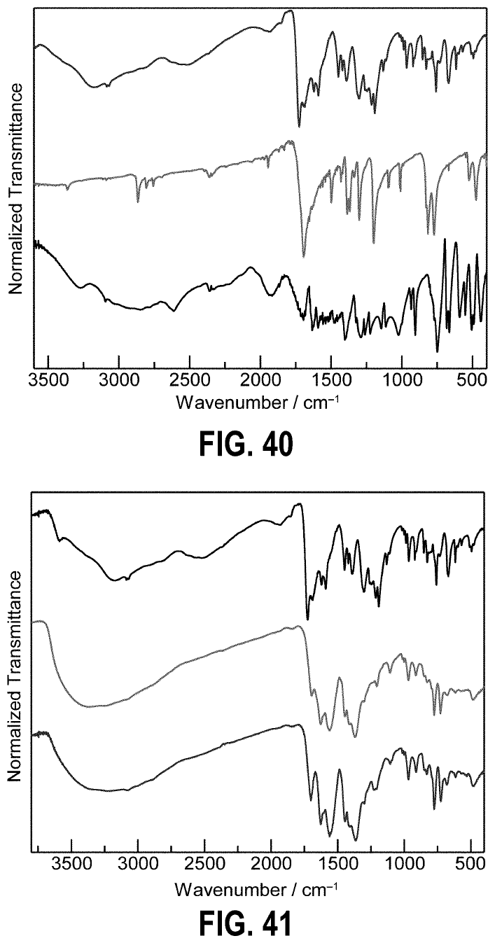

Besides group 4 element-based MOFs, the programmability of the solid-state mechanochemistry further manifests in its unique access to phenylenebis(methylidynenitrilo)]bis[1,3-benzenedicarboxylic acid](H₄L⁶) and [Cu₂(L⁶)](FIG. 6A), isotopological to the classic MOF-505. The tetratopic H₄L⁶ was synthesized by milling 4-aminoisophthalic acid and terephthalaldehyde in a molar ratio of 2:1 at 30 Hz for 45 min with an NMR yield of 76% (FIG. 39). The resultant MOF, [Cu₂(L⁶)], represents an nbo topology, generated from two kinds of square planar nodes—copper paddlewheel secondary building units and ligands. Addition of Cu(OAc)₂·H₂O and DMF (η=0.90 μL/mg) into the mechanochemically resultant H₄L⁶ mixture followed with 60-min milling generated the crystalline phase of [Cu₂(L⁶)] with an overall yield of 93%, which represents a MOF never been accessed previously. Meanwhile, the cascade reaction starting from 4-aminoisophthalic acid, terephthalaldehyde, Cu(OAc)₂·H₂O, and DMF in one pot also delivers [Cu₂(L⁶)] in a yield of 90%, confirmed by PXRD (FIG. 6B). The experimental PXRD patterns of [Cu₂(L⁶)] are comparable to the calculated ones of [Cu₂(PDEB)](H₄PDEB=5,5-(1,4-phenylenedi-2,1-ethynediy1)bis(1,3-benzenecarboxylic acid)). [B. Zheng, R. Yun, J. Bai, Z. Lu, L. Du, Y Li, Inorg. Chem. 2013, 52, 2823-2829.] The shorter linker length of H₄L⁶ compared to H₄PDEB causes the PXRD peaks of [Cu₂(L⁶)] to shift toward the higher angles, resulting in smaller lattice parameters compared to [Cu₂(PDEB)]. The N₂ adsorption isotherms (FIG. 6C) at 77 K for the [Cu₂(L⁶)] samples obtained via stepwise and one-pot methods show consistent BET surface area values (FIG. 43): 2532 m²/g for the stepwise method and 2554 m²/g for the one-pot method (P/P₀=0.007-0.03). Other characterizations of H₄L⁶ and [Cu₂(L⁶)] can be seen in FIGS. 40-42 and the discussion therefor.

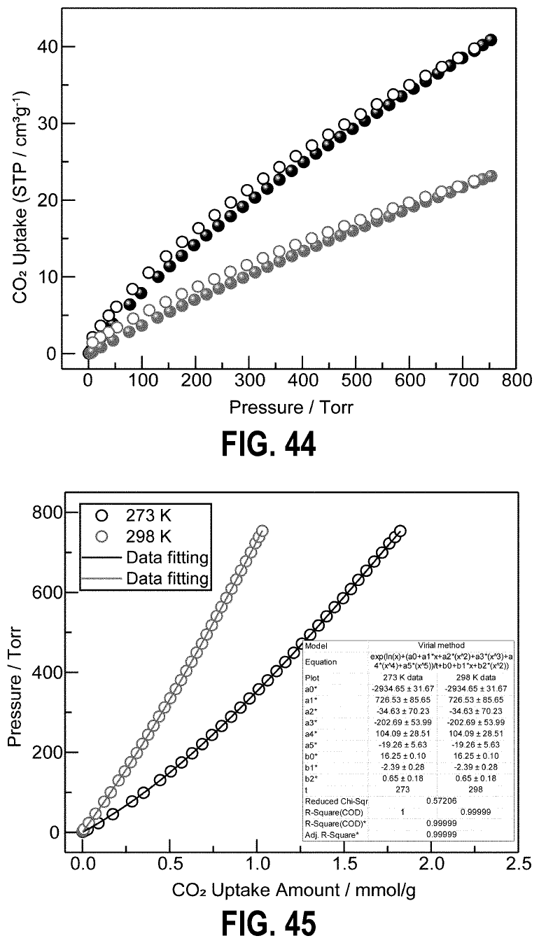

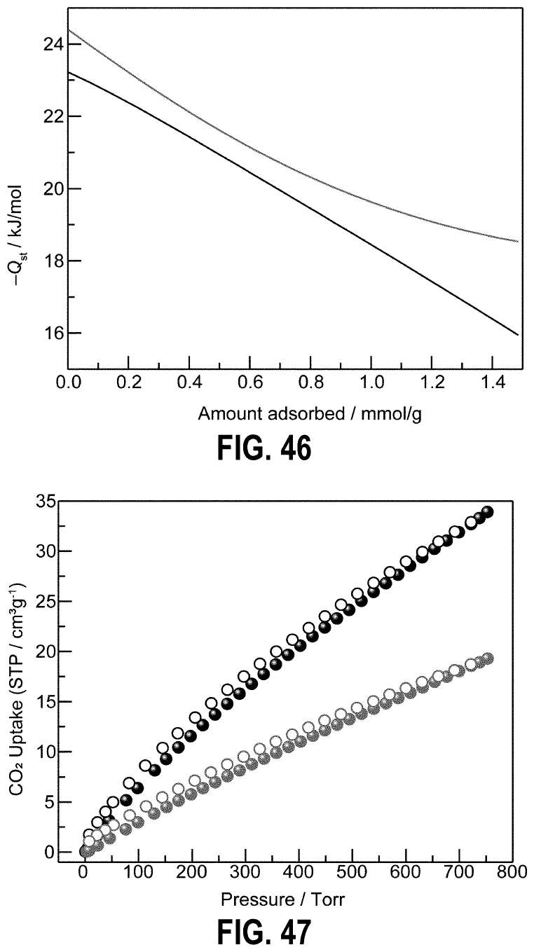

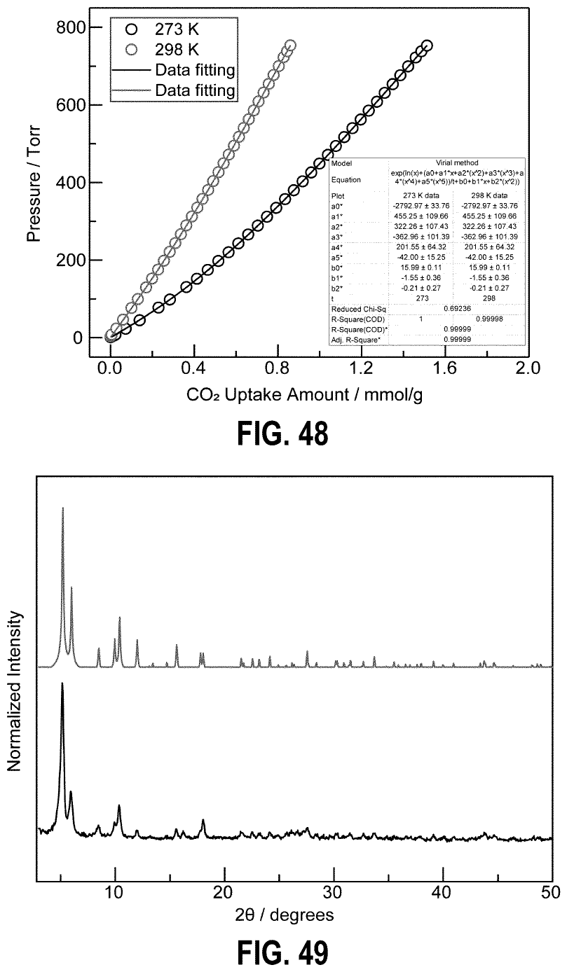

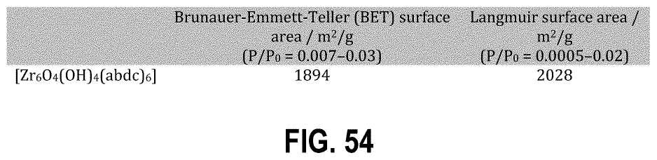

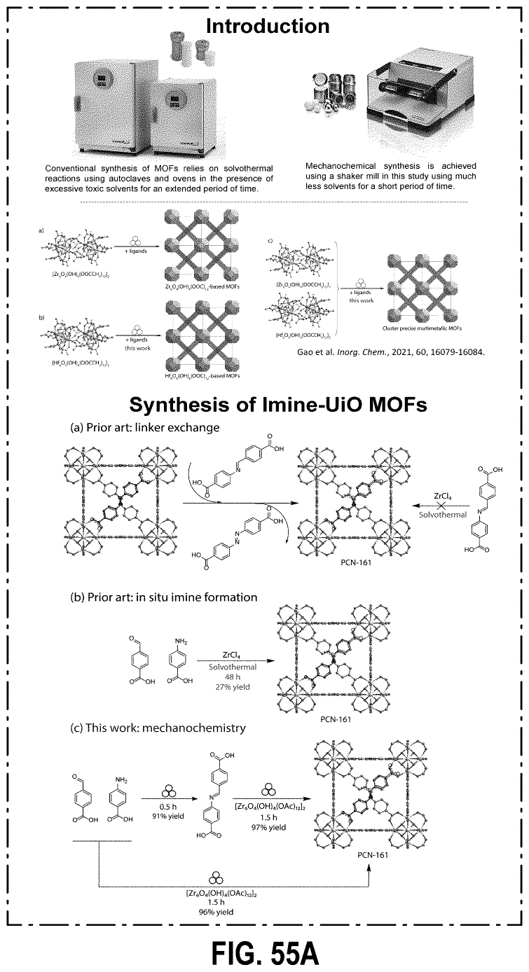

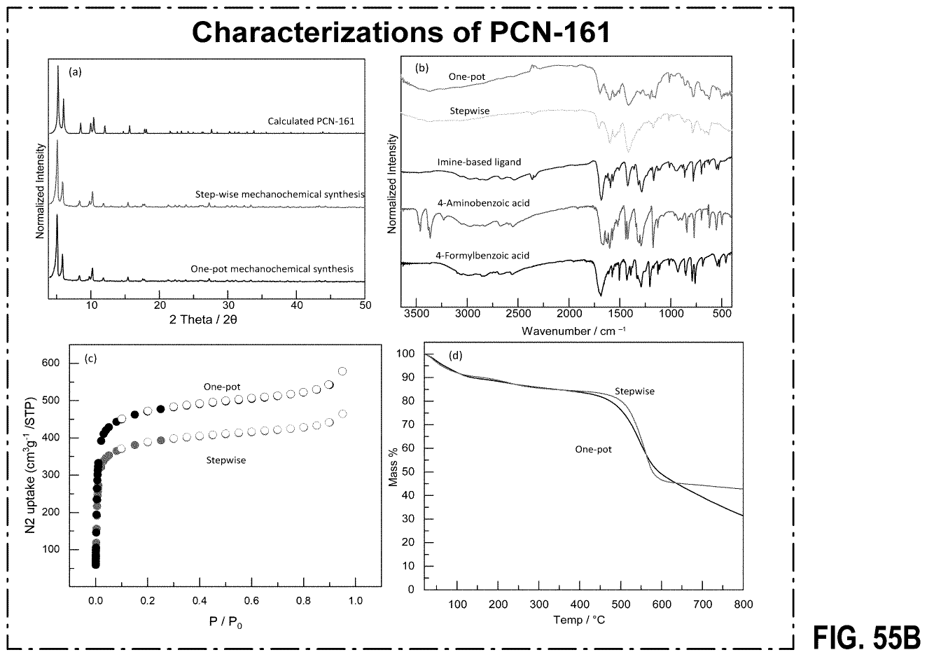

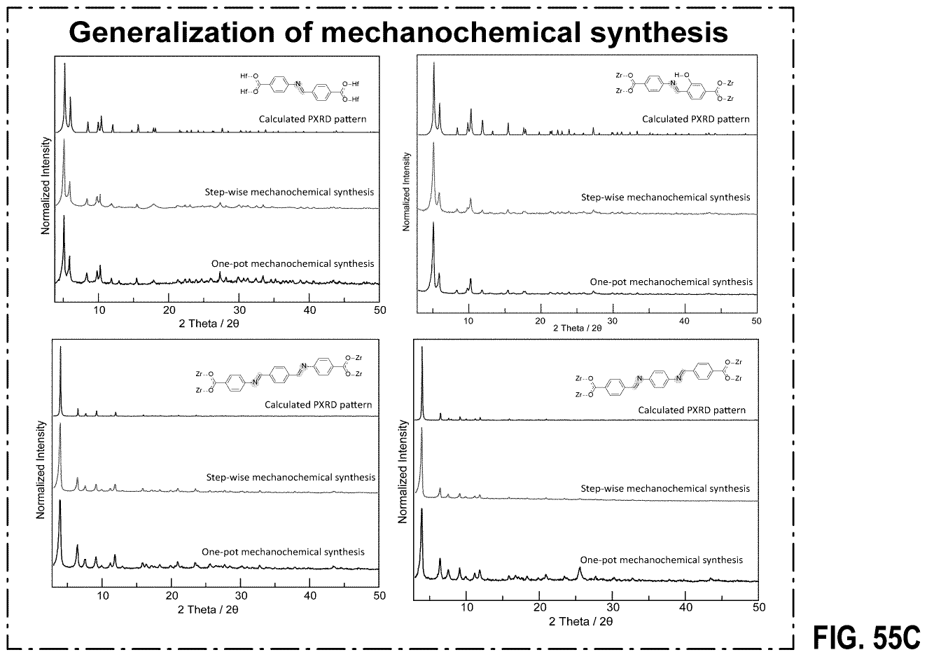

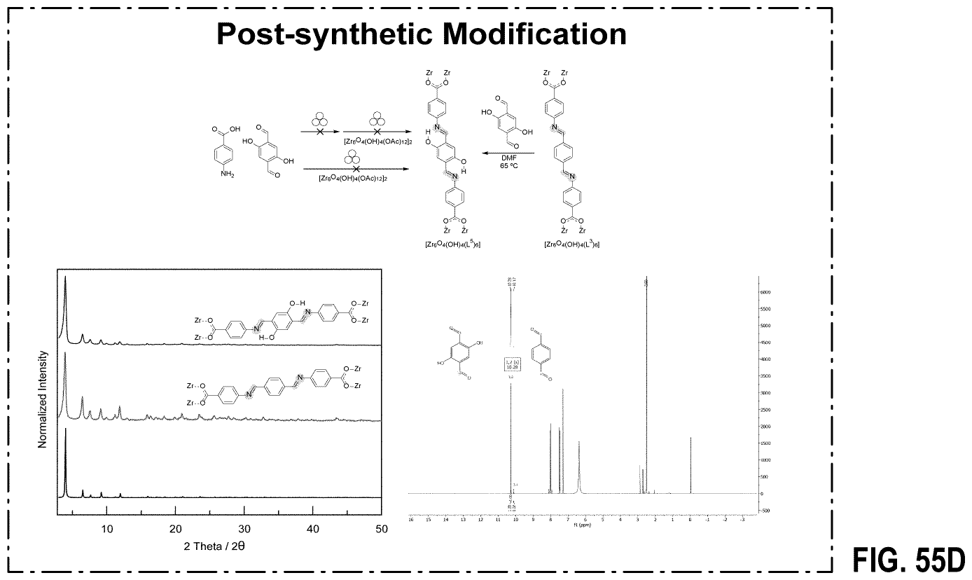

To probe the Lewis basicity of the imine motif, the present inventors measured carbon dioxide (CO₂) adsorption isotherms at 273 K and 298 K at low pressure (up to 1 bar, FIG. 44) and calculated the isosteric heat of adsorption (Qₛₜ) for the Lewis acidic CO₂. Using established virial analysis (FIG. 45),^{[23]}[A. Nuhnen, C. Janiak, Dalton Trans. 2020, 49, 10295-10307.] the Qₛₜ value (FIG. 46) for [Zr₆O₄(OH)₄(L¹)₆] at the initial CO₂ loading was determined to be 24.5 kJ/mol. To evaluate the CO₂ binding affinity of the imine motif and compare it to another Lewis basic group—the azo motif—the present inventors also collected the CO₂ adsorption isotherms of [Zr₆0₄(OH)₄(abdc)₆][W.-Y Gao, T. Thiounn, L. Wojtas, Y-S. Chen, S. Ma, Sci. China Chem. 2016, 59, 980-983](H₂abdc=azobenzene-4,4′-dicarbmlic acid) at 273 K and 298 K (FIG. 47) and calculated its Qₛₜ values (FIG. 46). The [Zr₆O₄(OH)₄(abdc)₆] sample was prepared using a similar mechanochemical reaction of H₂abdc and [Zr₆O₄(OH)₄(OAc)₁₂]₂ (See synthetic details and characterization in FIGS. 49-54). The azo motif exhibits a Qₛₜ value of 23.2 kJ/mol at initial CO₂ coverage, which is slightly lower than that of the imine motif.

In conclusion, the work of the present inventors as described herein reports a facile and universal synthetic strategy—mechanochemistry—to access an extended family of imine-based MOFs, which has been historically challenging using the solvothermal chemistry approach. The mechanochemical method exhibits the sustainable advantages of solvent volume reduction, short reaction time, and scale-up easiness, in addition to the high generalizability. Furthermore, the solid-state reaction nature at ambient temperature not only eliminates the decomposition pathway of the imine motif into the aldehyde and primary amine, but also promotes the imine condensation probed by the high-yield mechanochemical synthesis of ligands. What is truly remarkable is that the organic imine condensation and inorganic ligand substitution occur simultaneously, resulting in the desired MOF lattices. This process represents an inspiring example of a mechanochemical cascade reaction.

The various aspects and principles of the present invention will also be apparent from the following Examples.

### EXAMPLES

Materials Solvents were obtained as ACS reagent grade and used as received.

Unless otherwise noted, all chemicals and solvents were used as received. N,N-Dimethyl formamide (DMF) was obtained from Fischer Scientific. Acetone, methanol and dichloromethane were obtained from VWR Chemicals BDH. Glacial acetic acid was obtained from Fisher Chemical. Potassium bromide was obtained from Sigma-Aldrich. Ethanol (200 proof) was obtained from Decon laboratories, Inc. 4-Formyl-3-hydroxybenzoic acid, 4-formylbenzoic acid, 4-aminobenzoic acid, terephthalaldehyde, 5-aminoisophthalic acid, 4-nitrobenzoic acid, and copper (II) acetate monohydrate were obtained from AmBeed, Inc. Zirconium (IV) propoxide (ca. 70 wt % in 1-popanol) and d₆-dimethyl sulfoxide (d₆-DMSO) were obtained from Oakwood Chemical. Hafnium(IV) n-butoxide was obtained from Gelest, Inc. 1,4-phenylenediamine was purchased from TCI America. Deuterium chloride (DCI, 35 wt % in D₂O) was purchased from Cambridge Isotope Laboratories, Inc. Azobenzene-4,4′-dicarboxylic acid (H₂abdc) was synthesized according to the literature.¹ UHP-grade (99.999% purity) N₂, He, and CO₂ used in gas adsorption measurements were obtained from Linde. All reactions were carried out under an ambient atmosphere unless otherwise noted.

Mechanochemical Synthesis Mechanochemical synthesis was conducted using a Retsch Mixer Mill MM 400. Starting materials were typically loaded into a 10-mL polytetrafluoroethylene (PTFE) grinding jar with 2 PTFE grinding balls (10 mm Ø, 1.068±0.026 g) or a 10-mL stainless-steel grinding jar with 2 stainless-steel grinding balls (10 mm Ø, 4.046±0.001 g) for the milling experiments.

Characterization Details NMR spectra were recorded on a Bruker Ascend 500 MHz. Spectra were referenced against residual proton solvent resonance: d₆-DMSO (2.50 ppm, ¹H).^{2 1}H NMR data are reported as follows: chemical shift (δ, ppm), (multiplicity: s (singlet), d (doublet), t (triplet), quadruplet (q), m (multiplet), br (broad)); coupling constant J in Hz; integration. High-resolution mass spectrometry was carried out using a Thermo Fisher Scientific Q Exactive Plus hybrid quadrupole-Orbitrap mass spectrometer in the negative ion mode. Infrared (IR) spectra were recorded on a Thermo Scientific Nicolet iS20 DTGS. Spectra were blanked against KBr and determined by the average of 32 scans. IR data are reported as follows: wavenumber (cm⁻¹), (peak intensity: s, strong; m, medium; w, weak). Powder X-ray Diffraction (PXRD) measurements were carried out on a Rigaku Miniflex II (Cu Kα, 1.5406 Å; 40 kV, 15 mA). The angular range (26) was measured from 3.00 to 50.00° with a sampling width of 0.05° and a scan speed of 3.00° per minute. Simulated PXRD patterns were calculated using Mercury.³ Thermogravimetric analysis (TGA) was performed on a Shimadzu DTG-60 analyzer with a ramping rate of 15° C./min and a nitrogen flow rate of 50 mL/min.

Gas Adsorption Details N₂ adsorption isotherms (0-1.0 bar pressure range) were measured volumetrically at 77 K using an Anton PaarAutosorb-iQ. Each obtained solid sample was washed with acetone (15 mL×3). Then the sample was transferred under N₂ atmosphere to a pre-weighed analysis tube. The sample was evacuated at 120° C. until the outgas rate was <10 pbar/min and further maintained for 16 h. The analysis tube was weighed to determine the mass of the activated sample before the gas adsorption analysis. Brunauer-Emmett-Teller (BET) surface area values were calculated in the relative pressure range between 0.007 and 0.03.

### Example 1—Mechanochemical Synthesis of H₂L¹

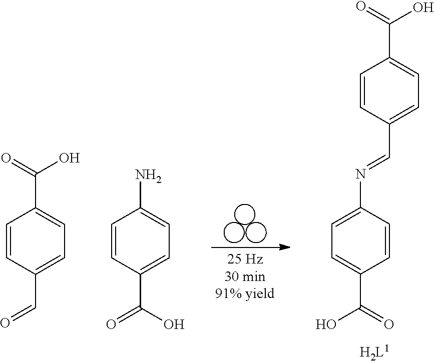 [SMILES: O=Cc1ccc(C(=O)O)cc1 ; Nc1ccc(C(=O)O)cc1 ; O=C(O)c1ccc(/C=N/c2ccc(C(=O)O)cc2)cc1]

A 10-mL PTFE grinding jar was charged with 2 PTFE grinding balls, 4-formylbenzoic acid (0.027 g, 0.18 mmol, 1.0 equiv), and 4-aminobenzoic acid (0.025 g, 0.18 mmol, 1.0 equiv). The resulting mixture was milled at 25 Hz for 30 min. The obtained solids were collected and dried under reduced pressure to the desired ligand, H₂L¹ (91% yield) as a white powder without further purification. Primary data are presented below: ¹H NMR (δ, 23° C., d₆-DMSO, FIG. 7), 13.04 (s, 2H), 8.74 (s, 1H), 8.08 (d, J=2.10 Hz, 4H), 7.99 (dt, J=8.61 Hz 2H), 7.36 (dt, J=8.57 Hz, 2H), matched with the reported NMR data;⁴ IR (cm⁻¹, FIG. 8), 3069 (w), 2979 (w), 2876 (w), 2811 (w), 2657 (w), 2535 (w), 1680 (s), 1631 (w), 1608 (w), 1591 (m), 1568 (s), 1504 (w), 1423 (m), 1362 (w), 1317 (m), 1285 (s), 1236 (w), 1187 (w), 1166 (m), 1125 (w), 1108 (w), 1012 (w), 945 (w), 884 (w), 863 (m), 700 (w), 667 (w), 636 (w), 621 (w), 553 (w), 532 (w); High-resolution mass spectrometry (ESI, negative) data, calc [C₁₅H₁₀NO₄]⁻: 268.0615, expt m/z=268.0617. ¹H NMR spectrum (FIG. 7) was collected on the solids after the milling without further purification, which indicates a yield of 91% for the Schiff base (H₂L) formation.

| | | | Additive | |
|---|---|---|---|---|
| | Frequency | Time | (solvent, | Yield |
| Entry | (Hz) | (min) | η = μL/mg) | (%) |
| 1 | 25 | 30 | none | 91 |
| 2 | 30 | 30 | none | 80 |
| 3 | 25 | 45 | none | 90 |
| 4 | 30 | 60 | none | 80 |
| 5 | 25 | 30 | MeOH, 0.3 | 86 |
| 6 | 25 | 30 | MeOH, 0.6 | 92 |
| 7 | 30 | 60 | MeOH, 0.3 | 92 |
| 8 | 30 | 60 | MeOH, 0.6 | 80 |

Table 1. Experimental parameters including milling frequency, time and liquid additive, have been explored to synthesize H₂L¹. The reaction outcomes are summarized above.

### Example 2—Stepwise Mechanochemical Synthesis of [Zr₆O₄(OH)₄(L′)₆]

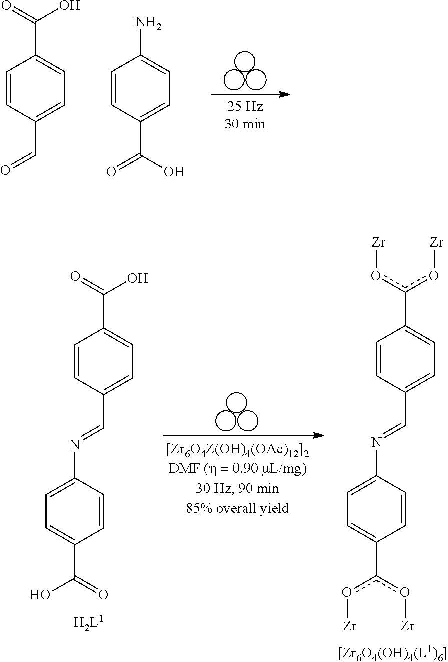

A 10-mL PTFE grinding jar was charged with 2 PTFE grinding balls, 4-formylbenzoic acid (0.027 g, 0.18 mmol, 12 equiv), and 4-aminobenzoic acid (0.025 g, 0.18 mmol, 12 equiv). The resulting mixture was milled at 25 Hz for 30 min. Then [Zr₆O₄(OH)₄(OAc)₁₂]₂ (0.042 g, 0.015 mmol, 1.0 equiv) and N,N-dimethylformamide (DMF, 85 μL, η=0.90 μL/mg) were added to the grinding jar. The mixture was milled at 30 Hz for 90 min. The obtained solids were collected and washed by acetone (15 mL×3). The solids were dried under reduced pressure to afford [Zr₆O₄(OH)₄(L¹)₆](0.058 g, 85% overall yield) as a white powder. Primary data are presented below: PXRD, FIGS. 2B and 9; IR (cm⁻¹, FIG. 10), 1695 (w), 1601 (m), 1554 (w), 1418 (s), 1299 (w), 1243 (w), 1206 (m), 1172 (w), 1155 (m), 1012 (w), 893 (w), 856 (w), 622 (m); TGA, FIG. 12; N₂ adsorption isotherm at 77 K, FIG. 2C.

### Example 3—Tandem Mechanochemical Synthesis of [Zr₆O₄(OH)₄(L′)₆]

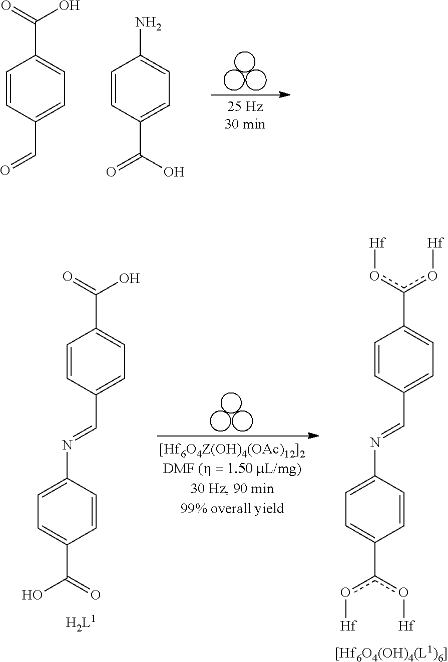

A 10-mL PTFE grinding jar was charged with 2 PTFE grinding balls, 4-formylbenzoic acid (0.027 g, 0.18 mmol, 12 equiv), and 4-aminobenzoic acid (0.025 g, 0.18 mmol, 12 equiv). The resulting mixture was milled at 25 Hz for 30 min. Then [Hf₆O₄(OH)₄(OAc)₁₂]₂ (0.066 g, 0.015 mmol, 1.0 equiv), wherein molecular weight of the Hf complex precursor was calculated as 4438.08 g/mol using the formula of [Hf₆O₄(OH)₄(OAc)₁₂]₂·10HOAc, obtained by the TGA plot of the synthesized sample, and DMF (177 μL η=1.50 μL/mg) were added to the grinding jar. The mixture was further milled at 30 Hz for 90 min. The obtained solids were collected and washed by acetone (15 mL×3). The solids were dried under reduced pressure to afford [Hf₆O₄(OH)₄(L¹)₆](0.086 g, 99% overall yield) as a white powder. Primary data are presented below: PXRD, FIG. 3C; IR (cm⁻¹, FIG. 14), 1697 (w), 1599 (m), 1552 (w), 1505 (w), 1419 (s), 1300 (w), 1204 (w), 1178 (m), 1145 (w), 1102 (w), 1015 (w), 980 (w), 963 (w), 893 (w), 855 (w), 783 (m), 667 (w), 627 (m); TGA, FIG. 15; N₂ adsorption isotherm at 77 K, FIG. 16.

### Example 4—Stepwise Mechanochemical Synthesis of [Hf₆O₄(OH)₄(L′)₆]

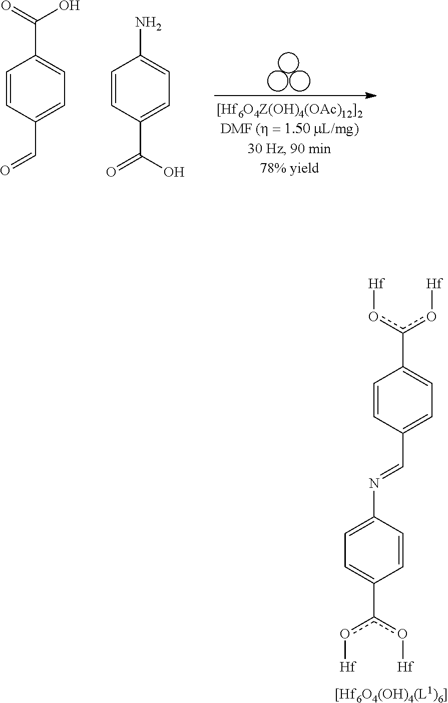

A 10-mL PTFE grinding jar was charged with 2 PTFE grinding balls, 4-formylbenzoic acid (0.027 g, 0.18 mmol, 12 equiv), 4-aminobenzoic acid (0.025 g, 0.18 mmol, 12 equiv), [Hf₆O₄(OH)₄(OAc)₁₂]₂ (0.066 g, 0.015 mmol, 1.0 equiv), and DMF (177 μL, η=1.50 μL/mg). The resulting mixture was milled at 30 Hz for 90 min. The obtained solids were collected and washed by acetone (15 mL×3). The solids were dried under reduced pressure to afford [Hf₆O₄(OH)₄(L¹)₆](0.067 g, 78% yield) as a white powder. Primary data are presented below: PXRD, FIG. 3C; IR (cm⁻¹, FIG. 14), 1707 (w), 1598 (m), 1553 (w), 1508 (w), 1421 (s), 1301 (w), 1196 (w), 1170 (w), 1149 (w), 1102 (w), 1014 (w), 978 (w), 960 (w), 892 (w), 855 (w), 780 (m), 710 (w), 625 (w); TGA, FIG. 15; N₂ adsorption isotherm at 77 K, FIG. 16.

### Example 5—Tandem Mechanochemical Synthesis of [Hf₆O₄(OH)₄(L′)₆]

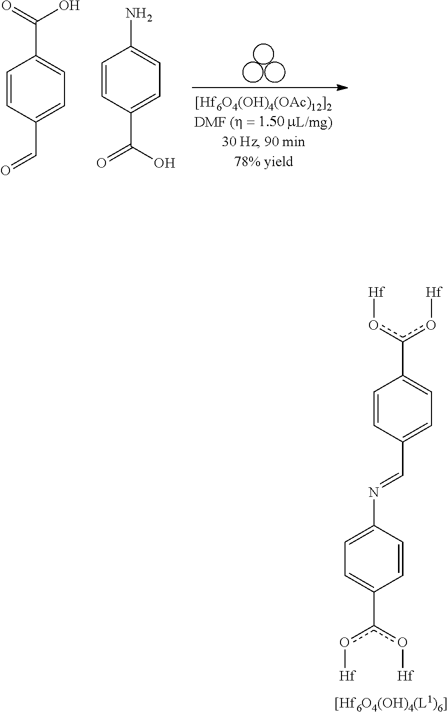

A 10-mL PTFE grinding jar was charged with 2 PTFE grinding balls, 4-formylbenzoic acid (0.027 g, 0.18 mmol, 12 equiv), 4-aminobenzoic acid (0.025 g, 0.18 mmol, 12 equiv), [Hf₆O₄(OH)₄(OAc)₁₂]₂ (0.066 g, 0.015 mmol, 1.0 equiv), and DMF (177 μL, η=1.50 μL/mg). The resulting mixture was milled at 30 Hz for 90 min. The obtained solids were collected and washed by acetone (15 mL×3). The solids were dried under reduced pressure to afford [Hf₆O₄(OH)₄(L¹)₆](0.067 g, 78% yield) as a white powder. Primary data are presented below: PXRD, FIG. 3C; IR (cm⁻¹, FIG. 14), 1707 (w), 1598 (m), 1553 (w), 1508 (w), 1421 (s), 1301 (w), 1196 (w), 1170 (w), 1149 (w), 1102 (w), 1014 (w), 978 (w), 960 (w), 892 (w), 855 (w), 780 (m), 710 (w), 625 (w); TGA, FIG. 15; N₂ adsorption isotherm at 77 K, FIG. 16.

### Example 6—Mechanochemical Synthesis of H₂L²

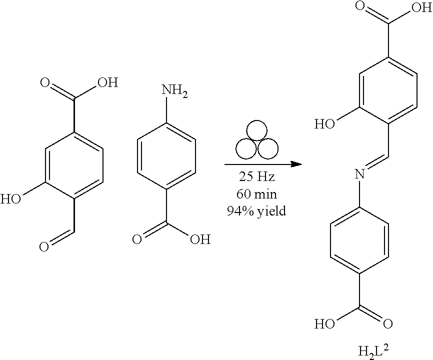

A 10-mL PTFE grinding jar was charged with 2 PTFE grinding balls, 4-formyl-3-hydroxybenzoic acid (0.030 g, 0.18 mmol, 1.0 equiv), and 4-aminobenzoic acid (0.025 g, 0.18 mmol, 1.0 equiv). The resulting mixture was milled at 25 Hz for 60 min. The obtained solids were collected and dried under reduced pressure to the desired ligand, H₂L² (94% yield) as an orange-colored powder without further purification. Primary data are presented below: ¹H NMR (δ, 23° C., d₆-DMSO, FIG. 18), 13.20 (br, 1H), 13.09 (br, 1H), 12.53 (s, 1H), 9.05 (s, 1H), 8.03 (d, J=8.62 Hz, 2H), 7.85 (d, J=8.08 Hz, 1H), 7.51 (m, 4H), matched with the reported NMR data;⁵ IR (cm⁻¹, FIG. 19), 1694 (s), 1682 (s), 1618 (w), 1595 (m), 1567 (w), 1554 (m), 1516 (w), 1503 (w), 1423 (m), 1359 (w), 1315 (m), 1285 (s), 1247 (m), 1223 (m), 1172 (s), 1096 (w), 1011 (w), 959 (w), 878 (w), 861 (w), 778 (m), 762 (m), 731 (w), 692 (w), 633 (w), 613 (w), 580 (w), 551 (m), 520 (w), 498 (w), 421 (w); High-resolution mass spectrometry (ESI, negative) data, calc [C₁₅H₁₀NO₅]⁻, 284.0564, expt m/z=284.0568. ¹H NMR spectrum (FIG. 18) was collected on the solids after the initial milling without further purification, which indicates a yield of 94% for the Schiff base (H₂L²) formation.

### Example 7—Stepwise Mechanochemical Synthesis of [Zr₆O₄(OH)₄(L²)₆]

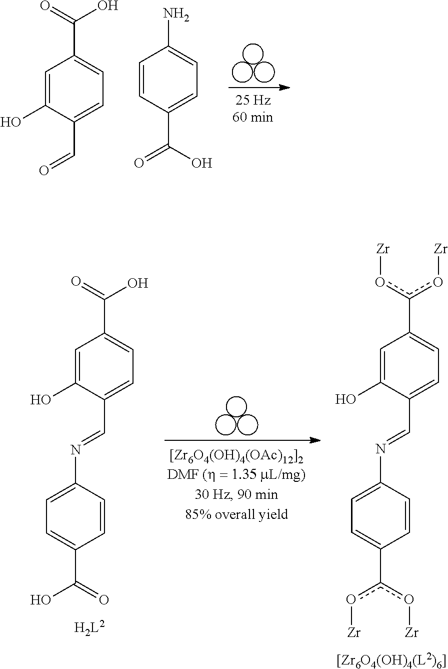

A 10-mL PTFE grinding jar was charged with 2 PTFE grinding balls, 4-formyl-3-hydroxybenzoic acid (0.030 g, 0.18 mmol, 12 equiv), and 4-aminobenzoic acid (0.025 g, 0.18 mmol, 12 equiv). The resulting mixture was milled at 25 Hz for 60 min. Then [Zr₆O₄(OH)₄(OAc)₁₂]₂ (0.042 g, 0.015 mmol, 1.0 equiv) and DMF (130 μL, η=1.35 μL/mg) were added to the grinding jar. The mixture was milled at 30 Hz for 90 min. The obtained solids were collected and washed by acetone (15 mL×3). The solids were dried under reduced pressure to afford [Zr₆O₄(OH)₄(L²)₆](0.061 g, 85% overall yield) as a pale orange powder. Primary data are presented below: PXRD, FIG. 3C; IR (cm⁻¹, FIG. 21), 1692 (w), 1596 (m), 1555 (m), 1417 (s), 1316 (w), 1248 (m), 1222 (m), 1173 (m), 1153 (w), 1101 (w), 1013 (w), 963 (w), 887 (w), 861 (w), 780 (m), 731 (w), 692 (w), 661 (w), 635 (m), 554 (w), 500 (m); TGA, FIG. 22; N₂ adsorption isotherm, FIG. 23.

### Example 8—Tandem Mechanochemical Synthesis of [Zr₆O₄(OH)₄(L²)₆]

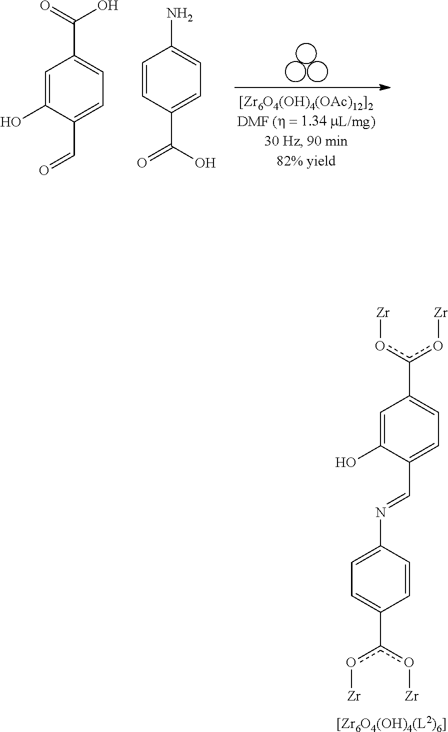

A 10-mL PTFE grinding jar was charged with 2 PTFE grinding balls, 4-formyl-3-hydroxybenzoic acid (0.030 g, 0.18 mmol, 12 equiv), 4-aminobenzoic acid (0.025 g, 0.18 mmol, 12 equiv), [Zr₆O₄(OH)₄(OAc)₁₂]₂ (0.042 g, 0.015 mmol, 1.0 equiv), and DMF (130 μL, η=1.34 μL/mg). The resulting mixture was milled at 30 Hz for 90 min. The obtained solids were collected and washed by acetone (15 mL×3). The solids were dried under reduced pressure to afford [Zr₆O₄(OH)₄(L²)₆](0.059 g, 82% yield) as a pale orange powder. Primary data are presented below: PXRD, FIGS. 3C and 20; IR (cm⁻¹, FIG. 21), 1693 (w), 1597 (m), 1555 (w), 1416 (s), 1361 (m), 1319 (w), 1265 (w), 1225 (w), 1174 (m), 1104 (w), 1014 (w), 965 (m), 888 (m), 860 (m), 783 (s), 734 (w), 637 (s); TGA, FIG. 22; N₂ adsorption isotherm at 77 K, FIG. 23.

### Example 9—Mechanochemical Synthesis of H₂L³

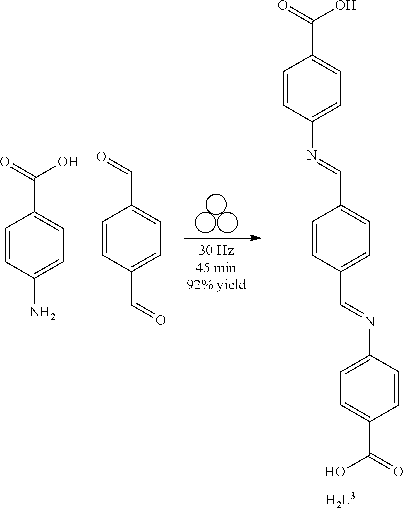

A 10-mL stainless steel grinding jar was charged with 2 stainless steel grinding balls, terephthalaldehyde (0.024 g, 0.18 mmol, 1.0 equiv), and 4-aminobenzoic acid (0.049 g, 0.36 mmol, 2.0 equiv). The resulting mixture was milled at 30 Hz for 45 min. The obtained solids were collected and dried under reduced pressure to the desired ligand, H₂L³ (92% yield) as a bright yellow colored powder without further purification. Primary data are presented below: ¹H NMR (δ, 23° C., d₆-DMSO, FIG. 26), 12.86 (br, 2H), 8.75 (s, 2H), 8.12 (s, 4H), 8.01 (d, J=8.50 Hz, 4H), 7.38 (d, J=8.50 Hz, 4H), matched with the reported NMR data;⁶ IR (cm⁻¹, FIG. 28), 3060 (w), 2972 (w), 2871 (w), 2795 (w), 2658 (w), 2534 (w), 1679 (s), 1627 (w), 1588 (s), 1564 (m), 1421 (m), 1312 (m), 1284 (s), 1191 (w), 1165 (m), 1127 (w), 1102 (w), 1009 (w), 968 (w), 943 (w), 876 (w), 858 (m), 832 (w), 772 (m), 695 (w), 641 (w), 613 (w), 546 (m), 499 (w), 460 (w); High-resolution mass spectrometry (ESI, negative) data, calc [C₂₂H₁₅N₂O₄]⁻: 371.1037, expt m/z=371.1041. ¹H NMR spectrum (FIG. 26) was collected on the solids after the milling without further purification, which indicates a yield of 96% for the Schiff base (H₂L³) formation.

### Example 10—Stepwise Mechanochemical Synthesis of [Zr₆O₄(OH)₄(L³)₆]

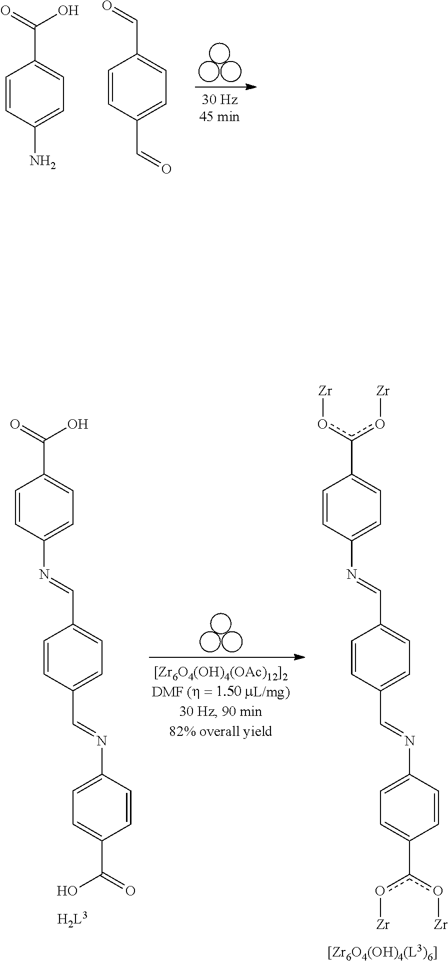

A 10-mL stainless steel grinding jar was charged with 2 stainless steel grinding balls, terephthalaldehyde (0.024 g, 0.18 mmol, 12 equiv), and 4-aminobenzoic acid (0.049 g, 0.36 mmol, 24 equiv). The resulting mixture was milled at 30 Hz for 45 min. Then the resulting mixture was transferred to a 10-mL PTFE grinding jar with 2 PTFE grinding balls. [Zr₆O₄(OH)₄(OAc)₁₂]₂ (0.042 g, 0.015 mmol, 1.0 equiv) and DMF (173 μL, η=1.50 μL/mg) were added to the PTFE jar. The mixture was further milled at 30 Hz for 90 min. The obtained solids were collected and washed by acetone (15 mL×3). The solids were dried under reduced pressure to afford [Zr₆O₄(OH)₄(L³)₆](0.072 g, 82% overall yield) as a beige powder. Primary data are presented below: PXRD, FIG. 4C; IR (cm⁻¹, FIG. 30), 1700 (w), 1596 (s), 1553 (m), 1413 (s), 1302 (w), 1194 (w), 1171 (m), 1101 (w) 1013 (w), 975 (w), 886 (w), 856 (w), 827 (w), 780 (m), 705 (m), 648 (m), 464 (w); TGA, FIG. 32; N₂ adsorption isotherm at 77 K, FIG. 34

### Example 11—Tandem Mechanochemical Synthesis of [Zr₆O₄(OH)₄(L³)₆]

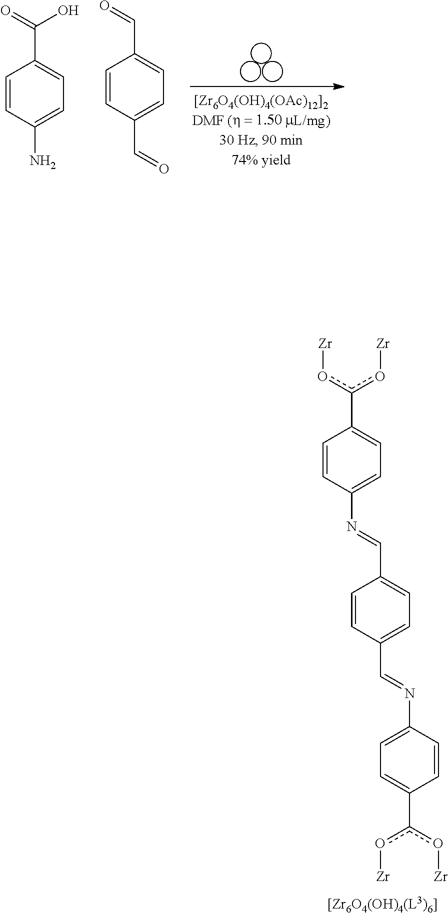

A 10-mL PTFE grinding jar was charged with 2 PTFE grinding balls, terephthalaldehyde (0.024 g, 0.18 mmol, 12 equiv), 4-aminobenzoic acid (0.049 g, 0.36 mmol, 24 equiv), [Zr₆O₄(OH)₄(OAc)₁₂]₂ (0.042 g, 0.015 mmol, 1.0 equiv), and DMF (173 μL, η=1.50 μL/mg). The mixture was milled at 30 Hz for 90 min. The obtained solids were collected and washed by acetone (15 mL×3). The solids were dried under reduced pressure to afford [Zr₆O₄(OH)₄(L³)₆](0.064 g, 74% yield) as a beige powder. Primary data are presented below: PXRD, FIG. 4C; IR (cm⁻¹, FIG. 30), 1686 (w), 1596 (s), 1546 (m), 1415 (s), 1299 (w), 1191 (w), 1169 (m), 1103 (w), 1013 (w), 973 (w), 887 (w), 857 (w), 831 (w), 780 (m), 705 (w), 648 (m), 546 (w), 465 (m); TGA, FIG. 32; N₂ adsorption isotherm at 77 K, FIG. 34.

### Example 12—Mechanochemical Synthesis of H₂L⁴

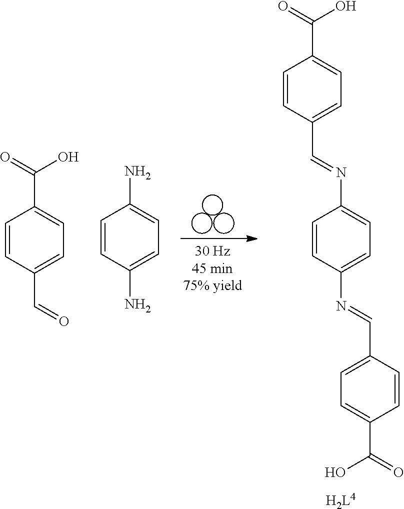

A 10-mL stainless steel grinding jar was charged with 2 stainless steel grinding balls, 1,4-phenylenediamine (0.020 g, 0.18 mmol, 1.0 equiv), and 4-formylbenzoic acid (0.054 g, 0.36 mmol, 2.0 equiv). The resulting mixture was milled at 30 Hz for 45 min. The obtained solids were collected and dried under reduced pressure to the desired ligand, H₂L⁴ (75% yield) as a pale-yellow colored powder without further purification. Primary data are presented below: ¹H NMR (δ, 23° C., d₆-DMSO, FIG. 27), 13.15 (br, 2H), 8.80 (s, 2H), 8.07 (m, 8H), 7.43 (s, 4H), matched with the reported NMR data;⁷ IR (cm⁻¹, FIG. 29), 3064 (w), 2978 (w), 2872 (w), 2805 (w), 2658 (w), 2538 (w), 1682 (s), 1620 (m), 1604 (w), 1565 (w), 1489 (w), 1420 (m), 1363 (w), 1315 (m), 1288 (s), 1191 (w), 1171 (w), 1123 (w), 1110 (w), 1197 (w), 1014 (w), 975 (w), 952 (w), 881 (w), 858 (m), 835 (w), 811 (w), 767 (m), 693 (m), 651 (w), 551 (m), 468 (w); High-resolution mass spectrometry (ESI, negative) data, calc [C₂₂H₁₅N₂O₄]⁻: 371.1037, expt m/z=371.1040. ¹H NMR spectrum (FIG. 27) was collected on the solids after the milling without further purification, which indicates a yield of 68% for the Schiff base (H₂L⁴) formation.

### Example 13—Stepwise Mechanochemical Synthesis of [Zr₆O₄(OH)₄(L⁴)₆]

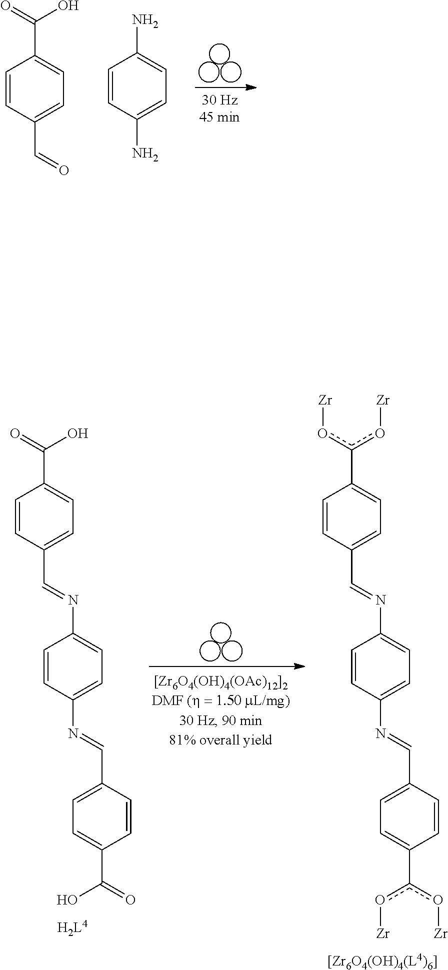

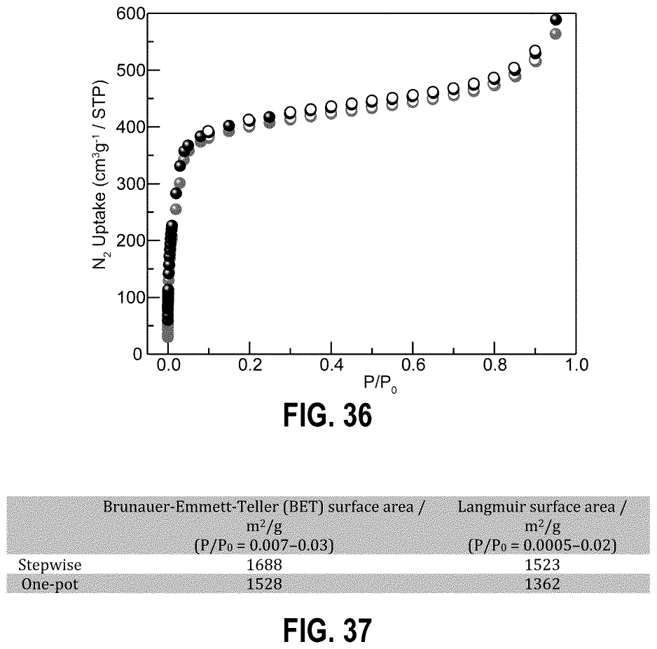

A 10-mL stainless steel grinding jar was charged with 2 stainless steel grinding balls, 1,4-phenylenediamine (0.020 g, 0.18 mmol, 12 equiv), and 4-formylbenzoic acid (0.054 g, 0.36 mmol, 24 equiv). The resulting mixture was milled at 30 Hz for 45 min. Then the resulting mixture was transferred to a 10-mL PTFE grinding jar with 2 PTFE grinding balls. [Zr₆O₄(OH)₄(OAc)₁₂]₂ (0.042 g, 0.015 mmol, 1.0 equiv) and DMF (174 μL, η=1.50 μL/mg) were added to the PTFE jar. The mixture was further milled at 30 Hz for 90 min. The obtained solids were collected and washed by acetone (15 mL×3). The solids were dried under reduced pressure to afford [Zr₆O₄(OH)₄(L⁴)₆](0.071 g, 81% overall yield) as a neon green powder. Primary data are presented below: PXRD, FIG. 4C; IR (cm⁻¹, FIG. 31), 1688 (w), 1596 (m), 1548 (w), 1503 (w), 1492 (w), 1418 (s), 1366 (m), 1294 (w), 1190 (w), 1170 (w), 1144 (w), 1101 (w), 1015 (w), 976 (w), 957 (w), 888 (w), 859 (w), 834 (w), 773 (m), 731 (w), 696 (w), 648 (m), 552 (w) 467 (m); TGA, FIG. 33; N₂ adsorption isotherm at 77 K, FIG. 36.

### Example 14—Tandem Mechanochemical Synthesis of [Zr₆O₄(OH)₄(L⁴)₆]

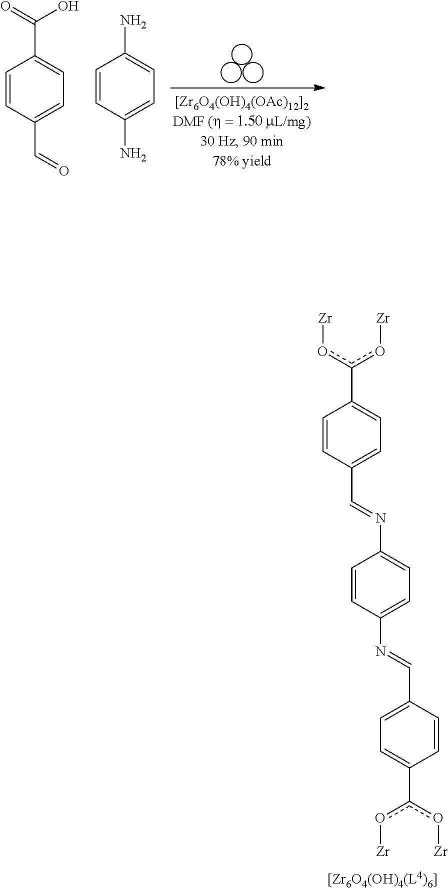

A 10-mL PTFE grinding jar was charged with 2 PTFE grinding balls, 1,4-phenylenediamine (0.020 g, 0.18 mmol, 12 equiv), and 4-formylbenzoic acid (0.054 g, 0.36 mmol, 24 equiv), [Zr₆O₄(OH)₄(OAc)₁₂]₂ (0.042 g, 0.015 mmol, 1.0 equiv), and DMF (174 μL, η=1.50 μL/mg). The resulting mixture was milled at 30 Hz for 90 min. The obtained solids were collected and washed by acetone (15 mL×3). The solids were dried under reduced pressure to afford [Zr₆O₄(OH)₄(L⁴)₆](0.068 g, 78% yield) as a neon green powder. Primary data are presented below: PXRD, FIG. 4C; IR (cm⁻¹, FIG. 31), 1690 (w), 1597 (m), 1552 (w), 1507 (w), 1492 (w), 1419 (s), 1360 (m), 1299 (w), 1193 (w), 1173 (w), 1147 (w), 1099 (w), 1015 (w), 976 (w), 958 (w), 887 (w), 861 (w), 839 (w), 778 (m), 731 (w), 701 (w), 650 (m), 557 (w), 468 (m); TGA, FIG. 33; N₂ adsorption isotherm at 77 K, FIG. 36.

### Example 15—Linker Exchange Synthesis of [Zr₆O₄(OH)₄(L⁶)₆]

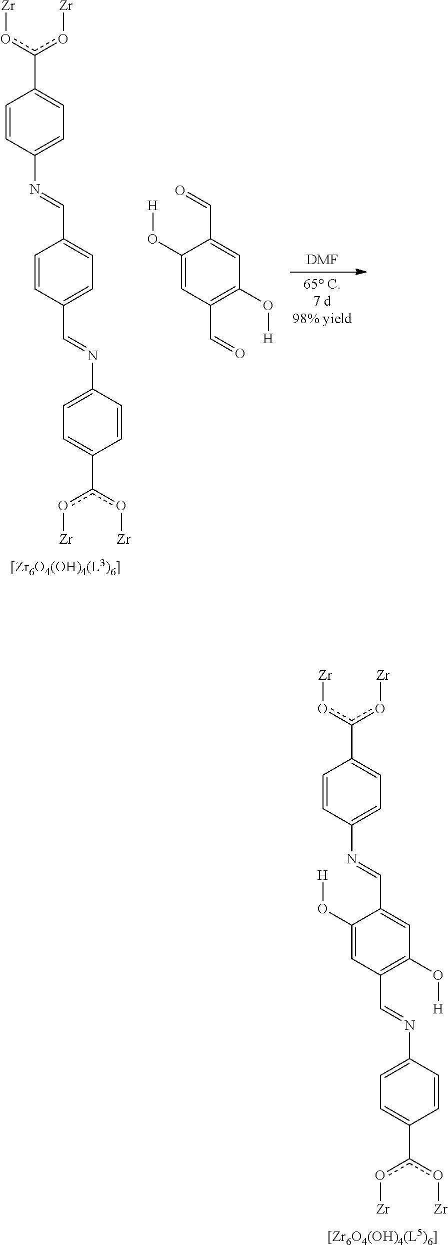

A 1-dram scintillation vial was charged with [Zr₆O₄(OH)₄(L³)₆](10 mg, 0.0035 mmol, 1.0 equiv, pre-activated 120° C. for 2 h), 2,5-dihydroxylterephthaldehyde (5.5 mg, 0.033 mmol, 9.4 equiv), and DMF (0.875 mL). The mixture was sealed and placed in an oven at 65° C. for 7 days. Then the reaction mixture was cooled down to 23° C. After the mother liquid being removed, the obtained solid was washed by DMF (3 mL×5) and acetone (3 mL×5). The solids were dried under reduced pressure to afford [Zr₆O₄(OH)₄(L⁵)₆] as an orange powder. The solid was digested in DMSO-d₆ with 1 drop of DCI (35 wt % in D₂O) and H NMR was collected to illustrate the exchange yield of 98%. Primary data are presented below: PXRD, FIG. 5B; ¹H NMR spectrum FIG. 38.

### Example 16—Mechanochemical Synthesis of [Zr₆O₄(OH)₄(abdc)₆]

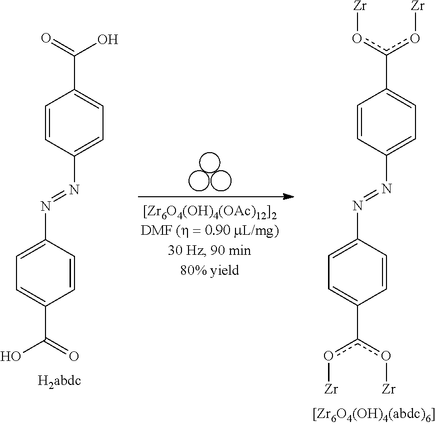

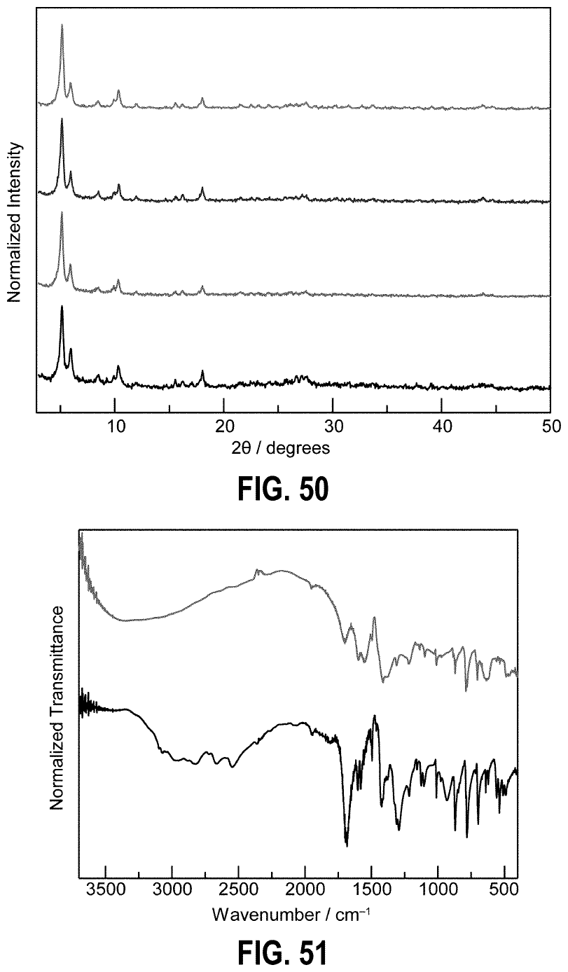

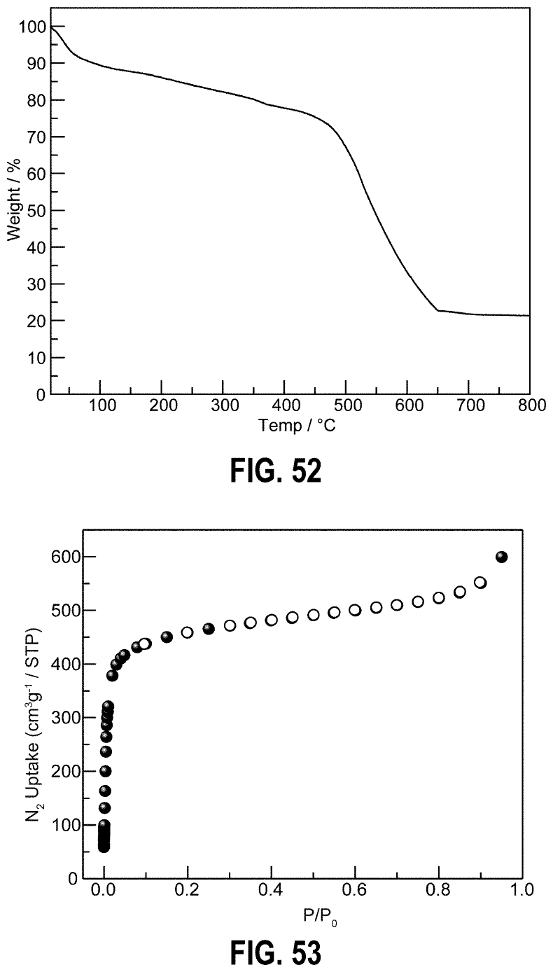

A 10-mL PTFE grinding jar was charged with 2 PTFE grinding balls, H₂abdc (0.050 g, 0.18 mmol, 12 equiv), [Zr₆O₄(OH)₄(OAc)₁₂]₂ (0.042 g, 0.015 mmol, 1.0 equiv), and DMF (83 μL, η=0.90 μL/mg). The resulting mixture was milled at 30 Hz for 90 min. The obtained solids were collected and washed by acetone (15 mL×3). The solids were dried under reduced pressure to afford [Zr₆O₄(OH)₄(abdc)₆](0.055 g, 80% yield) as an orange powder. Primary data are presented below: PXRD, FIGS. 49-50; IR (cm⁻¹, FIG. 51), 1701 (w), 1600 (m), 1548 (m), 1498 (w), 1411 (s), 1381 (s), 1309 (m), 1216 (m), 1138 (w), 1098 (w), 1009 (m), 875 (m), 788 (s), 781 (s), 703 (m), 634 (m); TGA, FIG. 52; N₂ adsorption isotherm at 77 K, FIG. 53.

### Example 17—Mechanochemical Synthesis of H₂L⁶

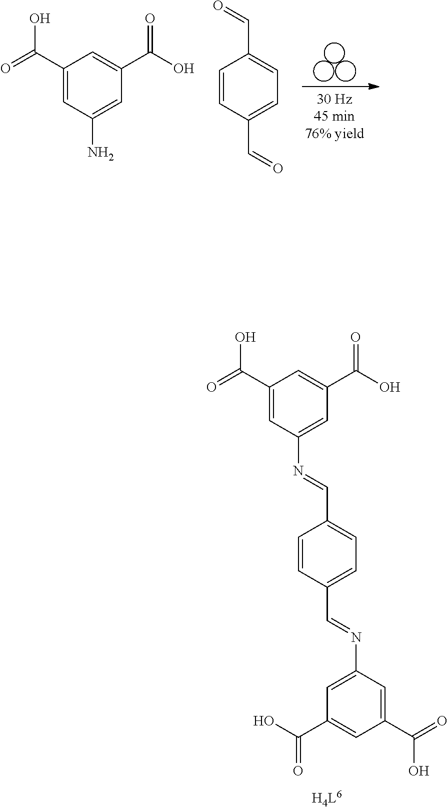

A 10-mL stainless steel grinding jar was charged with 2 stainless steel grinding balls, terephthalaldehyde (0.023 g, 0.17 mmol, 1.0 equiv), and 4-aminoisophthalic acid (0.062 g, 0.34 mmol, 2.0 equiv). The resulting mixture was milled at 30 Hz for 45 min. The obtained solids were collected and dried under reduced pressure to the desired ligand, H₄L⁶ (76% yield) as a dark yellow colored powder without further purification. Primary data are presented below: ¹H NMR (δ, 23° C., d₆-DMSO, FIG. 39), 13.35 (br, 4H), 8.87 (s, 2H), 8.38 (s, 2H), 8.15 (s, 4H), 8.05 (d, J=1.30 Hz, 4H); IR (cm⁻¹, FIG. 40), 3183 (w), 3083 (w), 3067 (w), 2524 (w), 1931 (w), 1725 (s), 1692 (m), 1619 (w), 1586 (w), 1451 (w), 1418 (w), 1390 (w), 1302 (m), 1260 (w), 1247 (w), 1214 (m), 1190 (m), 1131 (w), 1108 (w), 1013 (w), 1002 (w), 985 (w), 967 (w), 920 (w), 853 (w), 824 (w), 760 (m), 734 (w), 671 (m), 618 (w), 597 (w), 570 (w), 507 (w), 493 (w), 477 (w); High-resolution mass spectrometry (ESI, negative) data, calc [C₂₄H₁₄N₂O₈]²⁻: 229.0381, expt m/z=229.0382. ¹H NMR spectrum (FIG. 40) was collected on the solids after the milling without further purification, which indicates a yield of 76% for the Schiff base (H₄L⁶) formation.

### Example 18—Stepwise Mechanochemical Synthesis of [Cu₂(L⁶)]

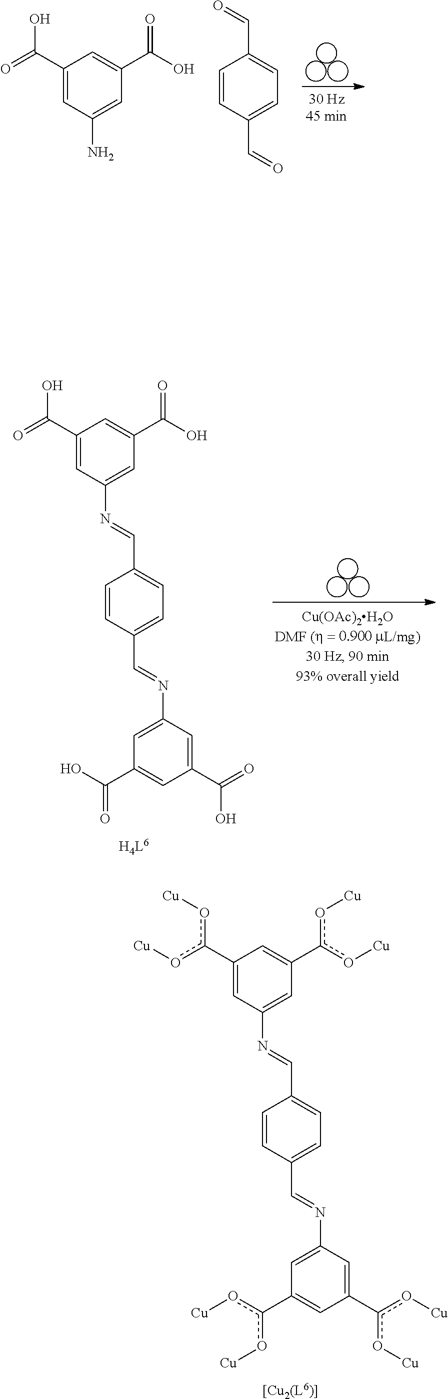

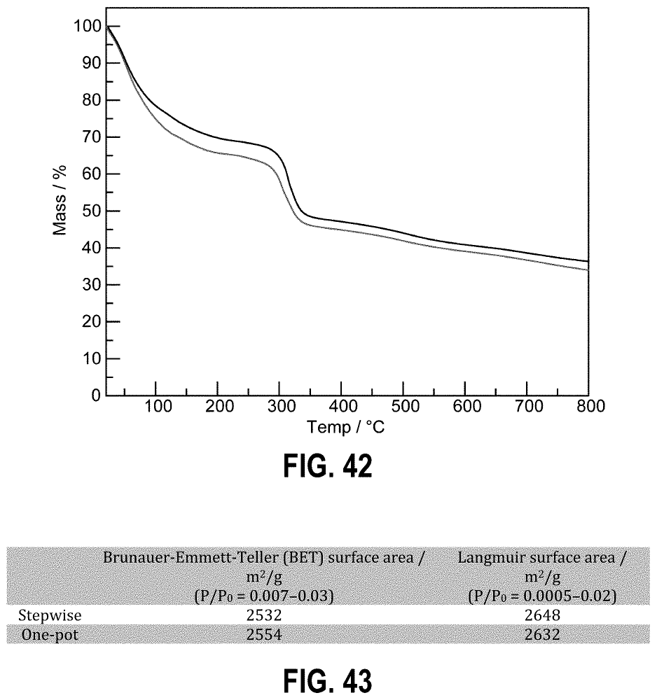

A 10-mL stainless steel grinding jar was charged with 2 stainless steel grinding balls, terephthalaldehyde (0.023 g, 0.17 mmol, 1.0 equiv), and 4-aminoisophthalic acid (0.062 g, 0.34 mmol, 2.0 equiv). The resulting mixture was milled at 30 Hz for 45 min. Then Cu(OAc)₂·H₂O (0.068 g, 0.34 mmol, 2.0 equiv) and DMF (138 μL, η=0.900 μL/mg) were added to the grinding jar. The mixture was further milled at 30 Hz for 90 min. The obtained solids were collected and washed by acetone (15 mL×3) with 1-min sonication in between. The solids were dried under reduced pressure to afford [Cu₂(L⁶)](0.092 g, 93% overall yield) as a blue powder. Primary data are presented below: PXRD, FIG. 6B; IR (cm⁻¹, FIG. 41), 1695 (w), 1629 (m), 1560 (s), 1444 (m), 1411 (m), 1370 (s), 1301 (w), 1205 (w), 1108 (w), 1012 (w), 1002 (w), 970 (w), 913 (w), 852 (w), 829 (w), 775 (m), 728 (m), 678 (w), 615 (w), 484 (w); TGA, FIG. 42; N₂ adsorption isotherm at 77 K, FIG. 6C.

### Example 19—Tandem Mechanochemical Synthesis of [Cu₂(L⁶)]

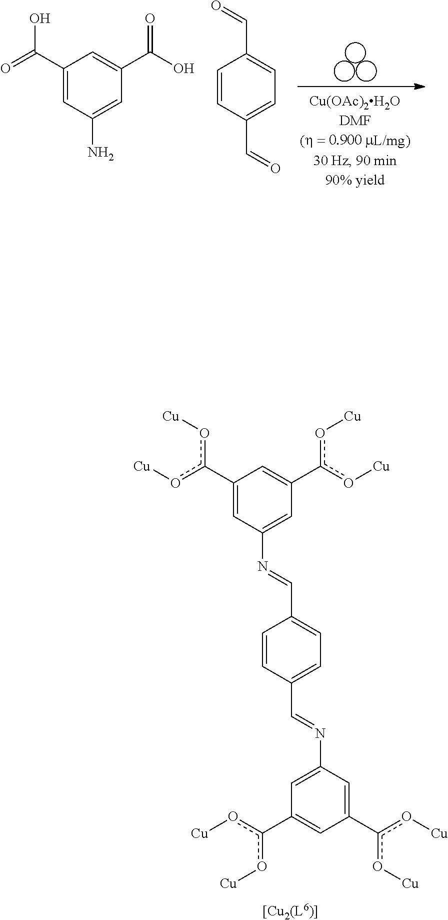

A 10-mL stainless steel grinding jar was charged with 2 stainless steel grinding balls, terephthalaldehyde (0.023 g, 0.17 mmol, 1.0 equiv), 4-aminoisophthalic acid (0.063 g, 0.35 mol, 2.0 equiv), Cu(OAc)₂·H₂O (0.068 g, 0.34 mmol, 2.0 equiv), and DMF (138 μL, η=0.900 μL/mg). The resulting mixture was milled at 30 Hz for 90 min. The obtained solids were collected and washed by acetone (15 mL×3). The solids were dried under reduced pressure to afford [Cu₂(L⁶)](0.089 g, 90% yield) as a blue powder. Primary data are presented below: PXRD, FIG. 6B; IR (cm⁻¹, FIG. 41), 1698 (w), 1627 (m), 1558 (s), 1445 (m), 1413 (m), 1367 (s), 1300 (w), 1223 (w), 1207 (w), 1107 (w), 1090 (w), 1014 (w), 1002 (w), 969 (w), 912 (w), 848 (w), 831 (w), 774 (m), 725 (m), 679 (w), 612 (w), 483 (w); TGA, FIG. 42; N₂ adsorption isotherm at 77 K, FIG. 6C.

The embodiments of the present invention recited herein are intended to be merely exemplary and those skilled in the art will be able to make numerous variations and modifications to it without departing from the spirit of the present invention. Notwithstanding the above, certain variations and modifications, while perhaps producing less than optimal results, may still produce satisfactory results. All such variations and modifications are intended to be within the scope of the present invention as defined by the claims appended hereto

What is claimed is:

1. A metal organic framework, comprising:
a linker molecule comprising an imine group and a linking moiety; and
a metal cluster, wherein the metal cluster comprises a plurality of metal atoms bound to oxygen atoms, and wherein the metal cluster is configured to coordinate with the linking moiety.

2. The metal organic framework of claim 1, wherein the linker molecule comprises a plurality of linking moieties.

3. The metal organic framework of claim 2, wherein the linker molecule comprises a first end and a second end, wherein the first end comprises the linking moiety, and wherein the second end comprises a second linking moiety.

4. The metal organic framework of claim 3, wherein the linker molecule is a ditopic linker molecule consisting of only two linking moieties.

5. The metal organic framework of claim 3, wherein first end further comprises a third linking moiety, and wherein the second end further comprises a fourth linking moiety.

6. The metal organic framework of claim 5, wherein the linker molecule is a tetratopic linker molecules consisting of only four linking moieties.

7. The metal organic framework of claim 1, wherein the linker moiety is selected from the group consisting of a carboxylic acid group, a pyridine group, and an azole group.

8. The metal organic framework of claim 3, wherein the linking moiety is selected from the group consisting of a carboxylic acid group, a pyridine group, and an azole group, and wherein the second linking moiety is different than the first linking moiety.

9. The metal organic framework of claim 5, wherein the linking moiety and the third linking moiety are the same and are selected from the group consisting of a carboxylic acid group, a pyridine group, and wherein the second linking moiety and the fourth linking moiety are the same and are different from the first linking moiety and the third linking moiety.

10. The metal organic framework of claim 5, wherein the linking moiety and the second linking moiety are the same and are selected from the group consisting of a carboxylic acid group, a pyridine group, and wherein the third linking moiety and the fourth linking moiety are the same and are different from the first linking moiety and the second linking moiety.

11. The metal organic framework of claim 3, wherein the first end comprises a first aromatic ring comprising the first linking moiety as a functional group attached thereto, and wherein the second end comprises a second aromatic ring comprising the second linking moiety as a functional group attached thereto.

12. The metal organic framework of claim 11, wherein the first aromatic ring is a benzene ring, and wherein the second aromatic ring is a benzene ring, wherein each benzene ring comprises a first carbon opposite a fourth carbon, a second carbon opposite a fifth carbon, and a third carbon opposite a sixth carbon, and wherein each carbon is adjacent to sequentially numbered carbons, and wherein the first carbon is adjacent to the sixth carbon.

13. The metal organic framework of claim 12, wherein the first aromatic ring and second aromatic ring are connected via a carbon chain, the carbon chain comprising:
a first portion connected to the first aromatic ring;
a second portion connected to the second aromatic ring; and
the imine group, wherein the imine group connects the first portion and the second portion of the carbon chain.

14. The metal organic framework of claim 13, wherein the first aromatic benzene ring comprises:
the carbon chain connected to the first carbon; and
the linking moiety connected to the fourth carbon,
and wherein the second aromatic benzene ring comprises:
the carbon chain connected to the first carbon; and
the second linking moiety connected to the fourth carbon.

15. The metal organic framework of claim 12, wherein the first aromatic ring and second aromatic ring are connected via a carbon chain, and wherein the carbon chain comprises a branch not used to connect the first aromatic ring and the second aromatic ring, and wherein the branch comprises the imine group.

16. The metal organic framework of claim 5, wherein the first end comprises a first aromatic ring comprising the first linking moiety and third linking moiety as functional groups attached thereto, and wherein the second end comprises a second aromatic ring comprising the second linking moiety and the fourth linking moiety as functional groups attached thereto.

17. The metal organic framework of claim 16, wherein the first aromatic ring is a benzene ring, and wherein the second aromatic ring is a benzene ring, wherein each benzene ring comprises a first carbon opposite a fourth carbon, a second carbon opposite a fifth carbon, and a third carbon opposite a sixth carbon, and wherein each carbon is adjacent to sequentially numbered carbons, and wherein the first carbon is adjacent to the sixth carbon.

18. The metal organic framework of claim 17, wherein the first aromatic ring and second aromatic ring are connected via a carbon chain, the carbon chain comprising:
a first portion connected to the first aromatic ring;
a second portion connected to the second aromatic ring; and
the imine group, wherein the imine group connects the first portion and the second portion of the carbon chain.

19. The metal organic framework of claim 18, wherein the first aromatic benzene ring comprises:
the carbon chain connected to the first carbon;
the linking moiety connected to the third carbon; and
the third linking moiety connected to the fifth carbon,
and wherein the second aromatic benzene ring comprises:
the carbon chain connected to the first carbon; and
the second linking moiety connected to the third carbon; and
the fourth linking moiety connected to the fifth carbon.

20. The metal organic framework of claim 17, wherein the first aromatic ring and second aromatic ring are connected via a carbon chain, and wherein the carbon chain comprises a branch not used to connect the first aromatic ring and the second aromatic ring, and wherein the branch comprises the imine group.

21. The metal organic framework of claim 1, wherein the plurality of metal atoms comprises zirconium.

22. The metal organic framework of claim 1, wherein the plurality of metal atoms comprises hafnium.

23. The metal organic framework of claim 1, wherein the plurality of metal atoms comprises copper.

24. The metal organic framework of claim 1, wherein the plurality of metal atoms has an oxidation state selected from the list consisting of 4+ and 2+.

25. The metal organic framework of claim 1, wherein each metal atom is coordinated with greater than or equal to 4 and less than or equal to 8 oxygen groups.

26. The metal organic framework of claim 1, wherein the metal organic framework comprises a plurality of linker molecules.

27. The metal organic framework of claim 1, wherein the metal organic framework comprises a plurality of metal clusters.

28. The metal organic framework of claim 27, wherein the metal organic framework comprises a plurality of linker molecules.

29. The metal organic framework of claim 28, wherein each linker molecule comprises a plurality of linking moieties, and wherein each linker molecule is connected to multiple metal clusters.

30. The metal organic framework of claim 28, wherein each metal cluster is connected to greater than or equal to 4 linking molecules and less than or equal to 12 linking molecules.

31. The metal organic framework of claim 30, wherein each metal cluster is connected to 12 linking molecules, and wherein the plurality of metal atoms comprises zirconium, hafnium, or a combination thereof.

32. The metal organic framework of claim 30, wherein each metal cluster is connected to 4 linking molecules, and wherein the plurality of metal atoms comprises copper.

33. A mechanochemical method of synthesizing a metal organic framework, comprising:
linking at least two metal clusters using at least one linking molecule by applying mechanochemical force, wherein each linking molecule comprises:
a first aromatic ring and a second aromatic ring, wherein each aromatic ring comprises at least one linking moiety as a functional group attached thereto, and wherein each linking moiety is configured to coordinate with the at least two metal clusters; and
an imine group;
and wherein each metal cluster comprises:
a plurality of metal atoms bound to oxygen atoms, wherein the metal cluster is configured to coordinate with the linking moiety.

34. The method of claim 33, wherein at least one linking moiety is selected from the group consisting of a carboxylic acid group, a pyridine group, an azole group, or a combination thereof.

35. The method of claim 33, wherein each linking moiety is a ditopic linker.

36. The method of claim 33, wherein each linking moiety is a tritopic linker.

37. The method of claim 33, wherein each linking moiety is a tetratopic linker.

38. The method of claim 33, wherein the plurality of aromatic rings is connected via a carbon chain comprising the imine group.

39. The method of claim 38, wherein the carbon chain comprises:
a first portion connected to a first aromatic ring;
a second portion connected to a second aromatic ring, wherein the second portion is connected to the first portion via the imine group.

40. The method of claim 33, wherein the imine group is positioned in a branch of the carbon chain, and wherein the branch does not connect the plurality of aromatic rings.

41. The method of claim 38, wherein the carbon chain further comprises a second imine group and a third aromatic ring, wherein the first aromatic ring is connected to a first portion of the carbon chain, wherein the first portion of the carbon chain is connected to the imine group, wherein the imine group is connected to the third aromatic ring, wherein the third aromatic ring is connected to the second imine group, wherein the second imine group is connected to a second portion of the carbon chain, and wherein the second portion of the carbon chain is connected to the second aromatic ring.

42. The method of claim 33, wherein applying mechanochemical force comprises the use of a mechanochemical agitation system selected from the list consisting of ball mill, a mixer mill, a grinding mill, an extruder mill, a rotating drum mill, and a combination thereof.

43. The method of claim 33, wherein applying the mechanochemical force comprises the use of mixing balls.

44. The method of claim 33, wherein applying mechanochemical force does not comprise the use of mixing balls.

45. The method of claim 33, wherein applying mechanochemical force is completed in less than or equal to 12 hours.

46. The method of claim 33, wherein applying mechanochemical force is completed in less than or equal to 6 hours.

47. The method of claim 33, wherein applying mechanochemical force is completed in less than or equal to 2 hours.

48. The method of claim 33 further comprising forming the linking molecule from a first linking molecule portion comprising the first aromatic ring and a second linking molecule portion comprising the second aromatic ring.

49. The method of claim 48, wherein forming the linking molecule occurs simultaneously with linking the at least two metal clusters using at least one linking molecule via the simultaneous application of mechanochemical force to the at least two metal clusters, the first linking molecule portion, and the second linking molecule portion.

50. The method of claim 48, wherein forming the linking molecule occurs in a preliminary reaction step prior to linking the at least two metal clusters using the at least one linking molecule.

51. The method of claim 50, wherein the preliminary reaction step comprises the application of mechanochemical force to the first linking molecule portion and the second linking molecule portion.

52. The method of claim 50, wherein the preliminary reaction step does not comprise the use of any solvent.

53. The method of claim 33, wherein the linking step comprises the use of solvent.

54. The method of claim 53, wherein the ratio of solvent volume to a combined mass of the linker molecules and metal clusters is greater than or equal to 0.6 μL/mg and less than or equal to 40 μL/mg.

55. The method of claim 53, wherein the ratio of solvent volume to a combined mass of the linker molecules and metal clusters is greater than or equal to 0.6 μL/mg and less than or equal to 10 μL/mg.

56. The method of claim 53, wherein the ratio of solvent volume to a combined mass of the linker molecules and metal clusters is greater than or equal to 0.6 μL/mg and less than or equal to 1.5 μL/mg.

57. The method of claim 53, wherein the ratio of solvent volume to a combined mass of the linker molecules and metal clusters is greater than or equal to 0.6 μL/mg and less than or equal to 1.05 μL/mg.

58. The method of claim 53, wherein the solvent is selected from the list consisting of N,N-dimethylformamide (DMF), N,N-Dimethylacetamide (DMA), ethanol, methanol, acetone, acetonitrile, or a combination thereof.

59. The method of claim 53, wherein the solvent is DMF.
